(19) United States
(12) Patent Application Publication
(10) Pub. No.: US 2015/0141112 A1
(43) Pub. Date: May 21, 2015

(54) ELECTRONIC GAMING DEVICE WITH PSEUDO GAMING FUNCTIONALITY

(71) Applicants: Marc McDermott, Lawrenceville, GA (US); Carmen DiMichele, Norcross, GA (US)

(72) Inventors: Marc McDermott, Lawrenceville, GA (US); Carmen DiMichele, Norcross, GA (US)

(73) Assignee: CADILLAC JACK, Duluth, GA (US)

(21) Appl. No.: 14/083,991

(22) Filed: Nov. 19, 2013

(51) Int. Cl. G07F 17/34

(52) U.S. Cl. CPC G07F 17/34
USPC 463/20

(57) ABSTRACT

Examples disclosed herein relate to an electronic gaming device including a memory, a processor, and a plurality of reels. The memory may include one or more pseudo feature structures. A processor may generate one or more symbols to be located in the one or more areas. The processor may generate one or more pseudo wagering options and the processor may accept one or more pseudo wagers relating to the one or more pseudo wagering options.

### FIELD

The subject matter disclosed herein relates to an electronic gaming device. More specifically, the disclosure relates to providing one or more pseudo functionalities on a gaming device.

### INFORMATION

The gaming industry has numerous casinos located both worldwide and in the United States. A client of a casino or other gaming entity can gamble via various games of chance. For example, craps, roulette, baccarat, blackjack, and electronic games (e.g., a slot machine) where a person may gamble on an outcome.

Paylines of an electronic gaming device (e.g., a slot machine) are utilized to determine when predetermined winning symbol combinations are aligned in a predetermined pattern to form a winning combination. A winning event occurs when the player successfully matches the predetermined winning symbols in one of the predetermined patterns.

A player's entertainment while playing one or more games may be enhanced by utilizing one or more pseudo functionalities on the gaming device. By increasing the player's entertainment level, the player's enjoyment of the game may be enhanced, which may increase a player's game playing period.

### BRIEF DESCRIPTION OF THE FIGURES

Non-limiting and non-exhaustive examples will be described with reference to the following figures, wherein like reference numerals refer to like parts throughout the various figures.

FIG. 1 is an illustration of the electronic gaming device, according to one embodiment.

FIG. 2 is an illustration of an electronic gaming system, according to one embodiment.

FIG. 3 is a block diagram of the electronic gaming device, according to one embodiment.

FIG. 4 is another block diagram of the electronic gaming device, according to one embodiment.

FIG. 5A is an illustration of pseudo game play on a gaming device, according to one embodiment.

FIG. 5B is another illustration of pseudo game play on a gaming device, according to one embodiment.

FIG. 5C is another illustration of pseudo game play on a gaming device, according to one embodiment.

FIG. 5D is another illustration of pseudo game play on a gaming device, according to one embodiment.

FIG. 5E is another illustration of pseudo game play on a gaming device, according to one embodiment.

FIG. 6A is another illustration of pseudo game play on a gaming device, according to one embodiment.

FIG. 6B is another illustration of pseudo game play on a gaming device, according to one embodiment.

FIG. 6C is another illustration of pseudo game play on a gaming device, according to one embodiment.

FIG. 6D is another illustration of pseudo game play on a gaming device, according to one embodiment.

FIG. 6E is another illustration of pseudo game play on a gaming device, according to one embodiment.

FIG. 7 is a game play flow diagram, according to one embodiment.

FIG. 8 is a game play flow diagram, according to one embodiment.

FIG. 9 is a game play flow diagram, according to one embodiment.

FIG. 10 is a flow diagram for game play, according to one embodiment.

FIG. 11 is a flow diagram for game play, according to one embodiment.

FIG. 12 is a flow diagram for game play, according to one embodiment.

FIG. 13 is a flow diagram for game play, according to one embodiment.

FIG. 14 is a flow diagram for game play, according to one embodiment.

FIG. 15 is a flow diagram for game play, according to one embodiment.

### DETAILED DESCRIPTION

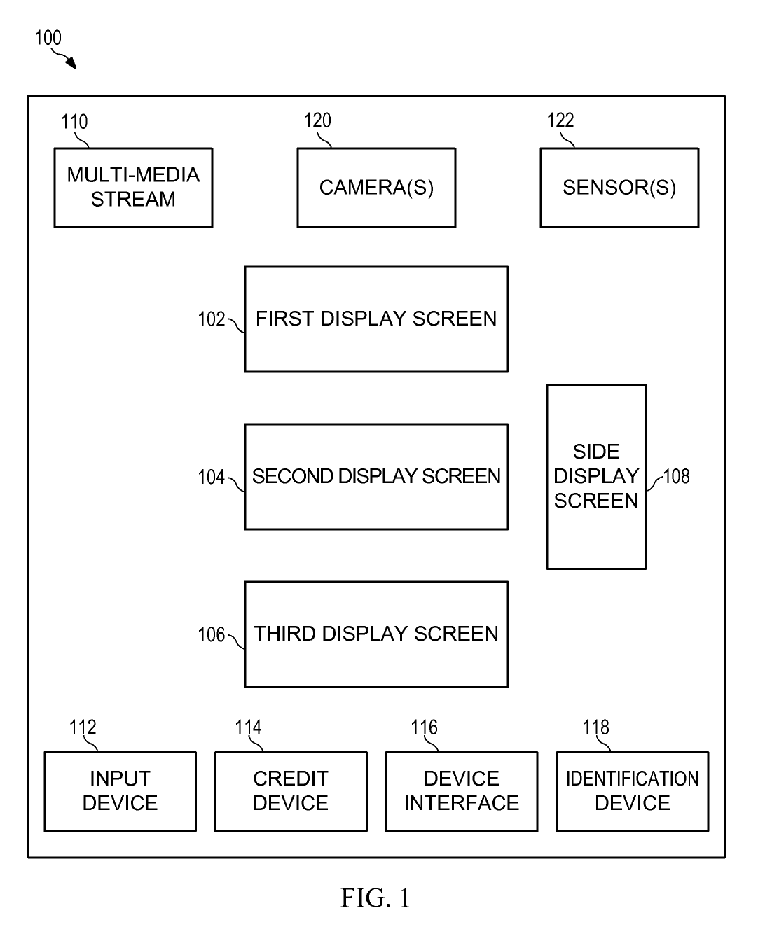

FIG. 1 is an illustration of an electronic gaming device 100. Electronic gaming device 100 may include a multi-media stream 110, a first display screen 102, a second display screen 104, a third display screen 106, a side display screen 108, an input device 112, a credit device 114, a device interface 116, and an identification device 118. Electronic gaming device 100 may display one, two, a few, or a plurality of multi-media streams 110, which may be obtained from one or more gaming tables, one or more electronic gaming devices, a central server, a video server, a music server, an advertising server, another data source, and/or any combination thereof.

Multi-media streams may be obtained for an entertainment event, a wagering event, a promotional event, a promotional offering, an advertisement, a sporting event, any other event, and/or any combination thereof. For example, the entertainment event may be a concert, a show, a television program, a movie, an Internet event, and/or any combination thereof. In another example, the wagering event may be a poker tournament, a horse race, a car race, and/or any combination thereof. The advertisement may be an advertisement for a casino, a restaurant, a shop, any other entity, and/or any combination thereof. The sporting event may be a football game, a baseball game, a hockey game, a basketball game, any other sporting event, and/or any combination thereof. These multi-media streams may be utilized in combination with the gaming table video streams.

Input device 112 may be mechanical buttons, electronic buttons, mechanical switches, electronic switches, optical switches, a slot pull handle, a keyboard, a keypad, a touch screen, a gesture screen, a joystick, a pointing device (e.g., a mouse), a virtual (on-screen) keyboard, a virtual (on-screen) keypad, biometric sensor, or any combination thereof. Input device 112 may be utilized to select one or more pseudo gaming options, to make a wager, to make a pseudo wager, to control any object, to select one or more pattern gaming options, to obtain data relating to historical payouts, to select a row and/or column to move, to select a row area to move, to select a column area to move, to select a symbol (or image) to move, to modify electronic gaming device 100 (e.g., change sound level, configuration, font, language, etc.), to select a movie or song, to select live multi-media streams, to request services (e.g., drinks, slot attendant, manager, etc.), to select two-dimensional (“2D”) game play, to select three-dimensional (“3D”) game play, to select both two-dimensional and three-dimensional game play, to change the orientation of games in a three-dimensional space, to move a symbol (e.g., wild, multiplier, etc.), and/or any combination thereof. These selections may occur via any other input device (e.g., a touch screen, voice commands, etc.). Input device 112 may be any control panel.

Credit device 114 may be utilized to collect monies and distribute monies (e.g., cash, vouchers, etc.). Credit device 114 may interface with a mobile device to electronically transmit money and/or credits. Credit device 114 may interface with a player's card to exchange player points.

Device interface 116 may be utilized to interface electronic gaming device 100 to a bonus game device, a local area progressive controller, a wide area progressive controller, a progressive sign controller, a peripheral display device, signage, a promotional device, network components, a local network, a wide area network, remote access equipment, a slot monitoring system, a slot player tracking system, the Internet, a server, and/or any combination thereof.

Device interface 116 may be utilized to connect a player to electronic gaming device 100 through a mobile device, card, keypad, identification device 118, and/or any combination thereof. Device interface 116 may include a docking station by which a mobile device is plugged into electronic gaming machine 100. Device interface 116 may include an over the air connection by which a mobile device is connected to electronic gaming machine 100 (e.g., Bluetooth, Near Field technology, and/or Wi-Fi technology). Device interface 116 may include a connection to identification device 118.

Identification device 118 may be utilized to determine an identity of a player. Based on information obtained by identification device 118, electronic gaming device 100 may be reconfigured. For example, the language, sound level, music, placement of multi-media streams, one or more game functionalities (e.g., game type 1, game type 2, game type 3, etc.) may be presented, a pseudo gaming option may be presented, a repeat payline gaming option may be presented, a pattern gaming option may be presented, historical gaming data may be presented, a row rearrangement option may be presented, a column rearrangement option may be presented, a row area rearrangement option may be presented, a column area rearrangement option may be presented, a two-dimensional gaming option may be presented, a three-dimensional gaming option may be presented, and/or the placement of gaming options may be modified based on player preference data. For example, the player may only want to play games that include pseudo gaming options only. Therefore, only games which include pseudo gaming options would be presented to the player. In another example, the player may only want to play games that include historical information relating to game play. Therefore, only games which include historical gaming data would be presented to the player. These examples may be combined.

Identification device 118 may utilize biometrics (e.g., thumb print, retinal scan, or other biometric). Identification device 118 may include a card entry slot into input device 112. Identification device 118 may include a keypad with an assigned pin number for verification. Identification device 118 may include multiple layers of identification for added security. For example, a player could be required to enter a player tracking card, and/or a pin number, and/or a thumb print, and/or any combination thereof. Based on information obtained by identification device 118, electronic gaming device 100 may be reconfigured. For example, the language, sound level, music, placement of video streams, placement of images, and the placement of gaming options utilized may be modified based on a player's preference data. For example, a player may have selected baseball under the sporting event preferences; electronic gaming device 100 will then automatically display the current baseball game onto side display screen 108 and/or an alternate display screen as set in the player's options.

First display screen 102 may be a liquid crystal display (“LCD”), a cathode ray tube display (“CRT”), organic light-emitting diode display (“OLED”), plasma display panel (“PDP”), electroluminescent display (“ELD”), a light-emitting diode display (“LED”), or any other display technology. First display screen 102 may be used for displaying primary games or secondary (bonus) games, to display one or more warnings relating to one or more audio devices, one or more display devices, one or more electrical wires, one or more springs, one or more motors, one or more adjustable devices, and/or one or more sensors, advertising, player attractions, electronic gaming device 100 configuration parameters and settings, game history, accounting meters, events, alarms, and/or any combination thereof. Second display screen 104, third display screen 106, side display screen 108, and any other screens may utilize the same technology as first display screen 102 and/or any combination of technologies.

First display screen 102 may also be virtually combined with second display screen 104. Likewise second display screen 104 may also be virtually combined with third display screen 106. First display screen 102 may be virtually combined with both second display screen 104 and third display screen 106. Any combination thereof may be formed.

For example, a single large image could be partially displayed on second display screen 104 and partially displayed on third display screen 106, so that when both display screens are put together they complete one image. Electronic gaming device 100 may stream or play prerecorded multi-media data, which may be displayed on any display combination.

One or more cameras 120 and/or one or more sensors 122 may be utilized as one or more depth image sensing devices, which may be located in various locations, including but not limited to, above the base display, above second display, in one or more locations on gaming cabinet front, on a side of the gaming cabinet other than gaming cabinet front, and/or any other location.

In one embodiment, electronic gaming device 100 may not include separate one or more input devices, but instead may only utilize one or more depth image sensing devices. In another embodiment, a player may utilize one or more input devices and/or may utilize gestures that electronic gaming device 100, via one or more depth image sensing devices, recognizes in order to make inputs for a play of a game. A player may interact with electronic gaming device 100 via one or more depth image sensing devices for a plurality of various player inputs.

In one embodiment, one or more depth image sensing devices may include at least two similar devices. For example, each of the at least two similar devices may independently sense depth and/or image of a scene. In another example, such similar depth image sensing devices may then communicate information to one or more processors, which may utilize the information from each of the similar depth image sensing devices to determine the relative depth of an image from a captured scene.

In another embodiment, one or more depth image sensing devices may include at least two different devices. For example, and discussed in more detail below, one of the at least two different devices may be an active device and/or one of the at least two different devices may be a passive device. In one example, such an active device may generate a wave of measurable energy (e.g., light, radio, etc.). In another example, such a passive device may be able to detect reflected waves generated by such an active device. In another example, such an active device and such a passive device may each communicate data related to their respective activity to a processor, and such processor may translate such data in order to determine the depth and/or image of a scene occurring near electronic gaming device 100.

Electronic gaming device 100 may include at least one display device. Electronic gaming device 100 may include a base display and/or a second display. In one embodiment, base display may be the primary display for a first game and/or one or more pseudo games. In another embodiment, second display may be the primary display for a second, bonus game, and/or one or more pseudo games. For example, base display may display: a reel-type video slot game; and upon a bonus game triggering condition; second display may display a bonus game; and upon a pseudo game feature triggering event; first and/or second display (and/or Nth displays) may display a pseudo game feature.

In one embodiment, base display and second display may display separate portions of a common image. For example, second display may display a top portion of a wheel spinning while base display may display the bottom portion of the same wheel spinning.

Electronic gaming device 100 may also include one or more speakers. In one embodiment, one or more speakers may work in a synchronized manner to provide a surround sound effect. For example, as an object is displayed moving across base display from left to right, one or more speakers may produce sound in such a manner as to create an audible sense of similar left to right movement. In another embodiment, one or more speakers may work asynchronously. In a further embodiment, a first speaker may produce sounds associated with a first symbol appearing in a play of a game, and a second speaker may produce sounds associated with a second symbol appearing in a play of the game.

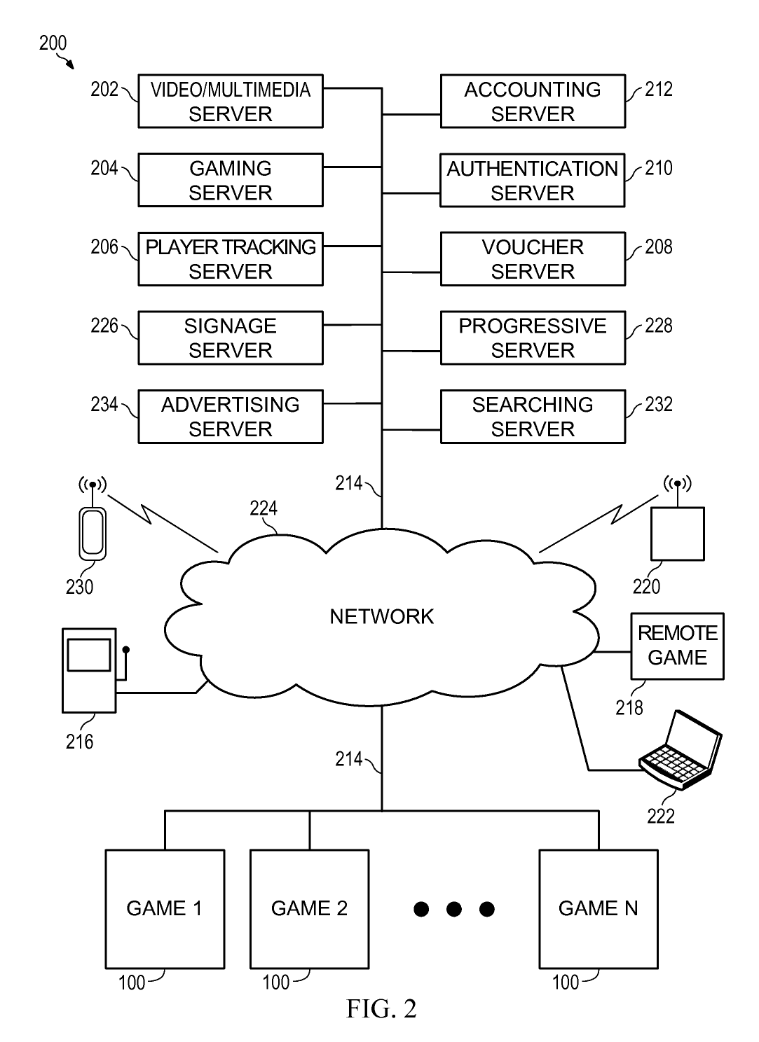

In FIG. 2, an electronic gaming system 200 is shown. Electronic gaming system 200 may include a video/multimedia server 202, a gaming server 204, a player tracking server 206, a voucher server 208, an authentication server 210, and an accounting server 212.

Electronic gaming system 200 may include video/multimedia server 202, which may be coupled to network 224 via a network link 214. Network 224 may be the Internet, a private network, and/or a network cloud. One or more video streams may be received at video/multimedia server 202 from other electronic gaming devices 100. Video/multimedia server 202 may transmit one or more of these video streams to a mobile phone 230, electronic gaming device 100, a remote electronic gaming device at a different location in the same property 216, a remote electronic gaming device at a different location 218, a laptop 222, and/or any other remote electronic device 220. Video/multimedia server 202 may transmit these video streams via network link 214 and/or network 224.

For example, a remote gaming device at the same location may be utilized at a casino with multiple casino floors, a casino that allows wagering activities to take place from the hotel room, a casino that may allow wagering activities (including pseudo wagers) to take place from the pool area, etc. In another example, the remote devices may be at another location via a progressive link to another casino, and/or a link within a casino corporation that owns numerous casinos (e.g., MGM, Caesars, etc.).

Gaming server 204 may generate gaming outcomes. Gaming server 204 may provide electronic gaming device 100 with game play content. Gaming server 204 may provide electronic gaming device 100 with game play math and/or outcomes. Gaming server 204 may provide one or more of: a pseudo game feature functionality; a pseudo game feature evaluation functionality; a payout functionality; a base and/or bonus game play functionality; a base and/or bonus game play evaluation functionality, other game functionality, and/or any other virtual game functionality.

Player tracking server 206 may track a player's betting activity, a player's preferences (e.g., language, font, sound level, drinks, etc.). Based on data obtained by player tracking server 206, a player may be eligible for gaming rewards (e.g., free play), promotions, and/or other awards (e.g., complimentary food, drinks, lodging, concerts, etc.).

Voucher server 208 may generate a voucher, which may include data relating to gaming. Further, the voucher may include pseudo wagering data and/or payline structure option selections. In addition, the voucher may include game play data (or similar game play data), repeat payline data, pattern data, historical payout data, column data, row data, and/or symbols that were modified.

Authentication server 210 may determine the validity of vouchers, player's identity, and/or an outcome for a gaming event.

Accounting server 212 may compile, track, and/or monitor cash flows, voucher transactions, winning vouchers, losing vouchers, pseudo wagering data, and/or other transaction data. Transaction data may include the number of wagers, the size of these wagers, the date and time for these wagers, the identity of the players making these wagers, the frequency of the wagers, and/or verification data, and/or confirmation data. Accounting server 212 may generate tax information relating to these wagers. Accounting server 212 may generate profit/loss reports for players' tracked outcomes.

Network connection 214 may be used for communication between dedicated servers, thin clients, thick clients, back-office accounting systems, etc.

Laptop computer 222 and/or any other electronic devices (e.g., mobile phone 230, electronic gaming device 100, etc.) may be used for downloading new gaming device applications or gaming device related firmware through remote access.

Laptop computer 222 and/or any other electronic device (e.g., mobile phone 230, electronic gaming device 100, etc.) may be used for uploading accounting information (e.g., cashable credits, non-cashable credits, coin in, coin out, bill in, voucher in, voucher out, etc.).

Network 224 may be a local area network, a casino premises network, a wide area network, a virtual private network, an enterprise private network, the Internet, or any combination thereof. Hardware components, such as network interface cards, repeaters and hubs, bridges, switches, routers, firewalls, or any combination thereof may also be part of network 224.

A statistics server may be used to maintain data relating to historical game play and/or pseudo wagering data for one or more electronic gaming devices 100 and/or other events. This historical data may include winning amounts, winning data (e.g., person, sex, age, time on machine, amount of spins before winning event occurred, etc.), fastest winning event reoccurrence, longest winning event reoccurrence, average frequencies of winning events, average winning amounts, highest winning amount, lowest winning amount, locations for winning events, winning event dates, winning machines, winning game themes, and/or any other data relating to game play.

Searching server 232 may implement a search on one or more gaming devices to obtain gaming data. Searching server 232 may implement a messaging function, which may transmit a message to a third party (e.g., a player) relating to a search, a search status update, a game status update, a wager status update, a confirmation of a wager, a confirmation of a money transfer, and/or any other data relating to the player's account. The message can take the form of a text display on the gaming device, a pop up window, a text message, an email, a voice message, a video message and the like. Searching server 232 may implement a wagering function, which may be an automatic wagering mechanism. These functions of searching server 232 may be integrated into one or more servers.

Searching server 232 may include one or more searching structures, one or more searching algorithms, and/or any other searching mechanisms. In general, the search structures may cover which EGMs paid out the most money during a time period, which EGMs kept the most money from players during a time period, which EGMs are the most popular (e.g., top games), which EGMs are the least popular, which EGMs have the most amount of money bet during a period, which EGMs have the highest bet volume, which EGMs are more volatile (e.g., volatility, or deviation from the statistical norms of bet volume, bet amount, pay out, etc.) during a time period, and the like. These searches may also be associated with location queries, time queries, and/or people queries (e.g., where are the table games that most of my friends bet on, where are my favorite EGMs, what are players betting on the most today, when are most bets placed, etc.).

The searching structures may be predetermined searching structures. For example, the method may start searching a first device, then a second device, then a third device, up to an N^{th} device based on one or more searching parameters (e.g., triggering event). In one example, the search may end once one or more triggering events are determined. In another example, the search may end once data has been received from a predetermined number (e.g., one, two, ten, one hundred, all) of the devices. In another example, the search may be based on a predetermined number of devices to be searched in combination with a predetermined number of search results to be obtained. In this example, the search structure may be a minimum of ten devices to be searched, along with a minimum of five gaming options to be determined.

In another example, the searching structures may be based on one or more specific games (e.g., a first EGM type, a second EGM type, etc.). Searching structure may search one or more of these games.

In another example, the searching structure may be based on a player's preferences, past transactional history, player input, a particular EGM, a particular casino, a particular location within a casino, game outcomes over a time period, payout over a time period, and/or any other criteria.

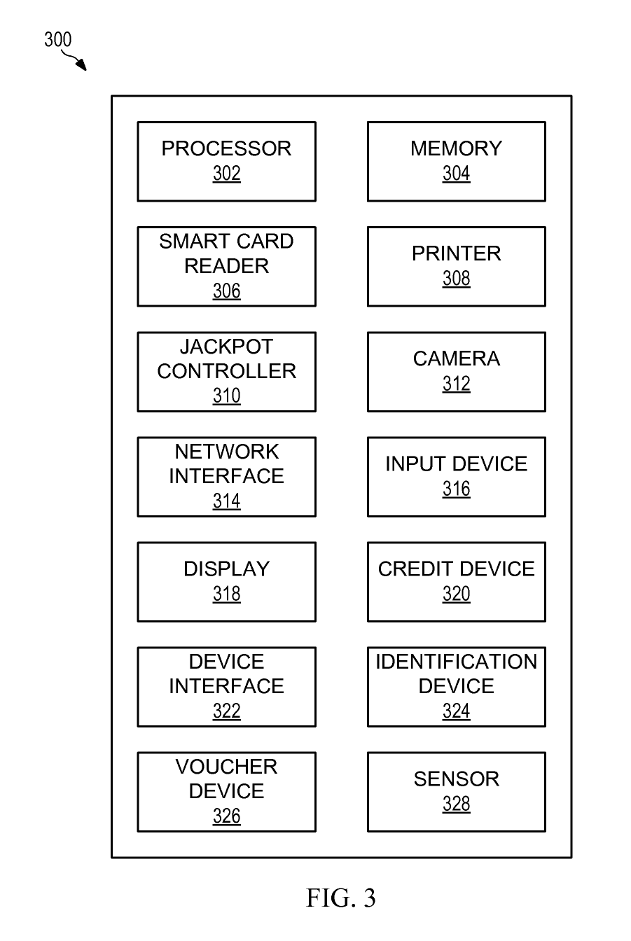

FIG. 3 shows a block diagram 300 of electronic gaming device 100. Electronic gaming device 100 may include a processor 302, a memory 304, a smart card reader 306, a printer 308, a jackpot controller 310, a camera 312, a network interface 314, an input device 316, a display 318, a credit device 320, a device interface 322, an identification device 324, and a voucher device 326.

Processor 302 may execute program instructions of memory 304 and use memory 304 for data storage. Processor 302 may also include a numeric co-processor, or a graphics processing unit (or units) for accelerated video encoding and decoding, and/or any combination thereof.

Processor 302 may include communication interfaces for communicating with electronic gaming device 100, electronic gaming system 200, and user interfaces to enable communication with all gaming elements. For example, processor 302 may interface with memory 304 to access a player's mobile device through device interface 322 to display contents onto display 318. Processor 302 may generate a voucher based on a wager confirmation, which may be received by an input device, a server, a mobile device, and/or any combination thereof. A voucher device may generate, print, transmit, or receive a voucher. Memory 304 may include communication interfaces for communicating with electronic gaming device 100, electronic gaming system 200, and user interfaces to enable communication with all gaming elements. For example, the information stored on memory 304 may be printed out onto a voucher by printer 308. Videos or pictures captured by camera 312 may be saved and stored on memory 304. Memory 304 may include a confirmation module, which may authenticate a value of a voucher and/or the validity of the voucher. Processor 302 may determine the value of the voucher based on generated voucher data and data in the confirmation module. Electronic gaming device 100 may include a player preference input device. The player preference input device may modify a game configuration. The modification may be based on data from the identification device.

Memory 304 may be non-volatile semiconductor memory, such as read-only memory (“ROM”), erasable programmable read-only memory (“EPROM”), electrically erasable programmable read-only memory (“EEPROM”), flash memory (“NVRAM”), Nano-RAM (e.g., carbon nanotube random access memory), and/or any combination thereof.

Memory 304 may also be volatile semiconductor memory such as, dynamic random access memory (“DRAM”), static random access memory (“SRAM”), and/or any combination thereof.

Memory 304 may also be a data storage device, such as a hard disk drive, an optical disk drive such as, CD, DVD, Blu-ray, a solid state drive, a memory stick, a CompactFlash card, a USB flash drive, a Multi-media Card, an xD-Picture Card, and/or any combination thereof.

Memory 304 may be used to store read-only program instructions for execution by processor 302, for the read-write storage for global variables and static variables, read-write storage for uninitialized data, read-write storage for dynamically allocated memory, for the read-write storage of the data structure known as “the stack,” and/or any combination thereof.

Memory 304 may be used to store the read-only paytable information for which symbol combinations on a given payline that result in a win (e.g., payout) which are established for games of chance, such as slot games and video poker.

Memory 304 may be used to store accounting information (e.g., cashable electronic promotion in, non-cashable electronic promotion out, coin in, coin out, bill in, voucher in, voucher out, electronic funds transfer in, etc.).

Memory 304 may be used to record error conditions on an electronic gaming device 100, such as door open, coin jam, ticket print failure, ticket (e.g., paper) jam, program error, reel tilt, etc., and/or any combination thereof.

Memory 304 may also be used to record the complete history for the most recent game played, plus some number of prior games as may be determined by the regulating authority.

Smart card reader 306 may allow electronic gaming device 100 to access and read information provided by the player or technician, which may be used for setting the player preferences and/or providing maintenance information. For example, smart card reader 306 may provide an interface between a smart card (inserted by the player) and identification device 324 to verify the identity of a player.

Printer 308 may be used for printing slot machine payout receipts, pseudo wager payouts, pseudo wagering vouchers, slot machine wagering vouchers, non-gaming coupons, slot machine coupons (e.g., a wagering instrument with a fixed waging value that can only be used for non-cashable credits), drink tokens, comps, and/or any combination thereof.

Electronic gaming device 100 may include a jackpot controller 310, which may allow electronic gaming device 100 to interface with other electronic gaming devices either directly or through electronic gaming system 200 to accumulate a shared jackpot.

Camera 312 may allow electronic gaming device 100 to take images of a player or a player's surroundings. For example, when a player sits down at the machine his or her picture may be taken to include his or her image into the game play. A picture of a player may be an actual image as taken by camera 312. A picture of a player may be a computerized caricature of the image taken by camera 312. The image obtained by camera 312 may be used in connection with identification device 324 using facial recognition. Camera 312 may allow electronic gaming device 100 to record video. The video may be stored on memory 304 or stored remotely via electronic gaming system 200. Videos obtained by camera 312 may then be used as part of game play, or may be used for security purposes. For example, a camera located on electronic gaming device 100 may capture videos of a potential illegal activity (e.g., tampering with the machine, crime in the vicinity, underage players, etc.).

Network interface 314 may allow electronic gaming device 100 to communicate with video/multimedia server 202, gaming server 204, player tracking server 206, voucher server 208, authentication server 210, and/or accounting server 212, and/or any other pseudo wagering related server (e.g., server to confirm another event (e.g., a horse race, football game, etc.)).

Input device 316 may be mechanical buttons, electronic buttons, a touch screen, and/or any combination thereof. Input device 316 may be utilized to make a wager, to make a pseudo wager, to select one or more game elements, to select one or more gaming options, to make an offer to buy or sell a voucher, to determine a voucher's worth, to cash in a voucher, to modify electronic gaming device 100 (e.g., change sound level, configuration, font, language, etc.), to modify one of one or more audio devices, one or more display devices, one or more electrical wires, one or more springs, one or more motors, one or more adjustable devices, and/or one or more sensors, to select a movie or music, to select live video streams (e.g., sporting event 1, sporting event 2, sporting event 3), to request services (e.g., drinks, manager, etc.), and/or any combination thereof.

Display 318 may show video streams from one or more content sources. Display 318 may encompass first display screen 102, second display screen 104, third display screen 106, side display screen 108, and/or another screen used for displaying video content.

Credit device 320 may be utilized to collect monies and distribute monies (e.g., cash, vouchers, etc.). Credit device 320 may interface with processor 302 to allow game play to take place. Processor 302 may determine any payouts, display configurations, animation, and/or any other functions associated with game play. Credit device 320 may interface with display 318 to display the amount of available credits for the player to use for wagering purposes. Credit device 320 may interface via device interface 322 with a mobile device to electronically transmit money and/or credits. Credit device 320 may interface with a player's pre-established account, which may be stored on electronic gaming system 200, to electronically transmit money and/or credit. For example, a player may have a credit card or other mag-stripe card on file with the location for which money and/or credits can be directly applied when the player is done. Credit device 320 may interface with a player's card to exchange player points.

Electronic gaming device 100 may include a device interface 322 that a user may employ with his or her mobile device (e.g., smart phone) to receive information from and/or transmit information to electronic gaming device 100 (e.g., watch a movie, listen to music, obtain verbal betting options, verify identification, transmit credits, etc.).

Identification device 324 may be utilized to allow electronic gaming device 100 to determine an identity of a player. Based on information obtained by identification device 324, electronic gaming device 100 may be reconfigured. For example, the language, sound level, music, placement of video streams, placement of images, placement of gaming options, and/or the tables utilized may be modified based on player preference data.

For example, a player may have selected a specific baseball team (e.g., Atlanta Braves) under the sporting event preferences, the electronic gaming device 100 will then automatically (or via player input) display the current baseball game (e.g., Atlanta Braves vs. Philadelphia Phillies) onto side display screen 108 and/or an alternate display screen as set in the player's options.

A voucher device 326 may generate, print, transmit, or receive a voucher. The voucher may represent a wagering option, a wagering structure, a wagering timeline, a value of wager, a payout potential, a payout, and/or any other wagering data. A voucher may represent an award, which may be used at other locations inside of the gaming establishment. For example, the voucher may be a coupon for the local buffet or a concert ticket.

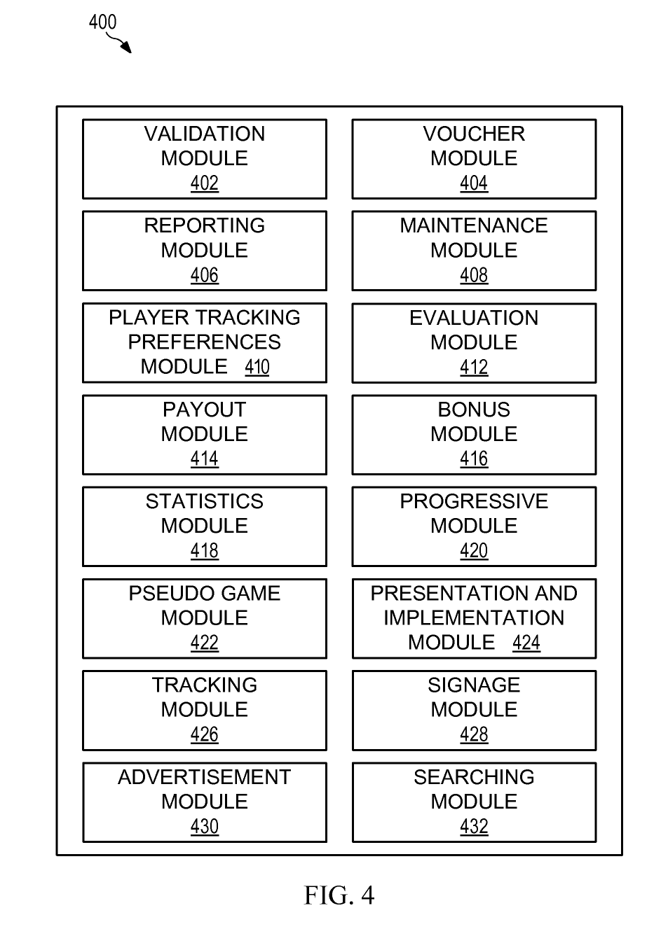

FIG. 4 shows a block diagram of memory 304, which includes various modules. Memory 304 may include a validation module 402, a voucher module 404, a reporting module 406, a maintenance module 408, a player tracking preferences module 410, an animation module, a game evaluation module 412, a payout module 414, a sensor module, a scene module, a sensor and scene evaluation module, a sensor and scene output module, a reference models module, an audio module, an audio device adjustment module, a display device adjustment module, a bonus module 416, a statistics module 418, a progressive module 420, a pseudo game module 422, a presentation and implementation module 424, a tracking module 426, a signage module 428, an advertisement module 430, and a searching module 432.

Validation module 402 may utilize data received from voucher device 326 to confirm the validity of the voucher.

Voucher module 404 may store data relating to generated vouchers, redeemed vouchers, bought vouchers, and/or sold vouchers.

Reporting module 406 may generate reports related to a performance of electronic gaming device 100, electronic gaming system 200, video streams, gaming objects, credit device 114, and/or identification device 118.

Maintenance module 408 may track any maintenance that is implemented on electronic gaming device 100 and/or electronic gaming system 200. Maintenance module 408 may schedule preventative maintenance and/or request a service call based on a device error.

Player tracking preferences module 410 may compile and track data associated with a player's preferences.

Animation module may generate, compile, transmit, and/or store one or more animations and/or presentations based on one or more scene data, one or more scenes, one or more reference models, one or more game play data, one or more player profiles, and/or any combination thereof.

Game evaluation module 412 may evaluate one or more outcomes for one or more events relating to game play.

Payout module 414 may determine one or more payouts which may relate to one or more inputs received from the player, electronic gaming device 100, and/or electronic gaming system 200.

Sensor module may generate, compile, transmit, and/or store any data relating to one or more scene data, one or more scene, and/or any other sensor data. This data may include one or more gestures (e.g., body movement made by one or more players).

Scene module may generate, compile, transmit, and/or store on one or more scene data, one or more scenes, one or more reference models, one or more game play data, one or more player profiles, and/or any combination thereof.

Sensor and scene evaluation module may evaluate any data stored on, transmitted to, and/or transmitted from sensor module and scene module. Sensor and scene evaluation module may obtain data including one or more gestures (e.g., body movement made by one or more players) from sensor module and compare this data to one or more body reference models, body part reference models, device reference models, gaming device reference models, floor plan reference models, and/or any other reference models from reference models module to determine one or more actions.

Sensor and scene output module may evaluate the combined output of sensor module and scene module.

Reference models module may generate, compile, transmit, and/or store one or more body reference models, body part reference models, device reference models, gaming device reference models, floor plan reference models, and/or any other reference models which can be utilized by any of the other modules.

Audio module may generate, compile, transmit, and/or store one or more audio structures, sound wave configurations, and/or any other audio data.

Audio device adjustment module may adjust one or more audio devices. These devices may be adjusted physically (e.g., moved) and/or by changing one or more device characteristics.

Display device adjustment module may adjust one or more display devices. These devices may be adjusted physically (e.g., moved) and/or by changing one or more device characteristics.

Bonus module 416 may generate a bonus game, evaluate the results of the bonus game, trigger bonus game presentations, generate bonus game payouts, and/or display any data relating to the bonus game.

Statistics module 418 may be used to maintain data relating to historical game play (including pseudo wagering data) for one or more electronic gaming devices 100. This historical data may include winning amounts, winning data (e.g., person, sex, age, time on machine, amount of spins before winning event occurred, etc.), fastest winning event reoccurrence, longest winning event reoccurrence, average frequencies of winning events, average winning amounts, highest winning amount, lowest winning amount, locations for winning events, winning event dates, winning machines, winning game themes, and/or any other data relating to game play.

Progressive module 420 may generate, transmit, compile, and/or store one or more data points relating to one or more progressives and/or subscription progressives (e.g., a progressive a player selects and pays to enter).

Pseudo game module 422 may generate, transmit, compile, and/or store one or more data points and/or presentations relating to one or more pseudo gaming options and/or pseudo gaming wagers.

Presentation and implementation module 424 may generate, transmit, compile, implement, and/or store one or more presentations.

Tracking module 426 may generate, transmit, compile, and/or store one or more data points related to tracking one or more pseudo wagers and/or pseudo wager players.

Signage module 428 may generate, transmit, compile, initiate, and/or store one or more presentations for one or more signs.

Advertisement module 430 may generate, transmit, compile, present, implement, initiate, and/or store one or more advertisements.

Searching module 432 may implement a search on one or more gaming devices to obtain gaming data. Searching module 432 may implement a messaging function, which may transmit a message to a third party (e.g., a player) relating to a search, a search status update, a game status update, a wager status update, a confirmation of a wager, a confirmation of a money transfer, and/or any other data relating to the player's account. The message can take the form of a text display on the gaming device, a pop up window, a text message, an email, a voice message, a video message and the like. Searching module 432 may implement a wagering function, which may be an automatic wagering mechanism. These functions of searching module may be integrated into one or more servers.

Searching module 432 may include one or more searching structures, one or more searching algorithms, and/or any other searching mechanisms. In general, the search structures may cover which EGMs paid out the most money during a time period, which EGMs kept the most money from players during a time period, which EGMs are the most popular (e.g., top games), which EGMs are the least popular, which EGMs have the most amount of money bet during a period, which EGMs have the highest bet volume, which EGMs are more volatile (e.g., volatility, or deviation from the statistical norms of bet volume, bet amount, pay out, etc.) during a time period, and the like. These searches may also be associated with location queries, time queries, and/or people queries (e.g., where are the table games that most of my friends bet on, where are my favorite EGMs, what are players betting on the most today, when are most bets placed, etc.).

The searching structures may be predetermined searching structures. For example, the method may start searching a first device, then a second device, then a third device, up to an N^{th} device based on one or more searching parameters (e.g., triggering event). In one example, the search may end once one or more triggering events are determined. In another example, the search may end once data has been received from a predetermined number (e.g., one, two, ten, one hundred, all) of the devices. In another example, the search may be based on a predetermined number of devices to be searched in combination with a predetermined number of search results to be obtained. In this example, the search structure may be a minimum of ten devices to be searched, along with a minimum of five gaming options to be determined.

In another example, the searching structures may be based on one or more specific games (e.g., a first EGM type, a second EGM type, etc.). Searching structure may search one or more of these games.

In another example, the searching structure may be based on a player's preferences, past transactional history, player input, a particular EGM, a particular casino, a particular location within a casino, game outcomes over a time period, payout over a time period, and/or any other criteria.

Wild module may generate a wild game, evaluate the results of the wild game, trigger wild game presentations, generate wild game payouts, and/or display any data relating to the wild game. Further, wild module may determine one or more outcomes of one or more interactions (e.g., collisions of one or more symbols).

Scatter module may generate a scatter game, evaluate the results of the scatter game, trigger scatter game presentations, generate scatter game payouts, and/or display any data relating to the scatter game.

Pseudo evaluation module may evaluate one or more outcomes for one or more events relating to pseudo game play. Further, pseudo evaluation module may determine one or more outcomes of one or more interactions.

Installation verification module may verify the installation parameters on one or more of audio devices, one or more display devices, one or more electrical wires, one or more springs, one or more motors, one or more adjustable devices, and/or one or more sensors to one or more reference data points. Installation verification module may generate a warning when the data points are outside of a specific parameter range. One or more warnings may be transmitted to an external device, a server, a mobile device, and/or a warning display on electronic gaming device 100 based on the verification data.

Locking module may control the locking mechanism for one or more audio devices, one or more display devices, one or more electrical wires, one or more springs, one or more motors, one or more adjustable devices, and/or one or more sensors. Locking module may control any locking mechanism for electronic gaming device 100. Locking module may generate a warning when a locking data point is outside of a specific parameter. These warnings may be transmitted to an external device, a server, a mobile device, and/or a warning display on electronic gaming device 100.

It should be noted that one or more modules may be combined into one module. Further, there may be one evaluation module where the determined payout does not depend on whether there were any wild symbols, scatter symbols, treasure based game play, and/or any other specific symbols. Further, any module, device, and/or logic function in electronic gaming device 100 may be present in electronic gaming system 200. In addition, any module, device, and/or logic function in electronic gaming system 200 may be present in electronic gaming device 100.

In one embodiment, a system based on one or more pseudo games may be offered that are dependent on a function of a primary slot machine and/or any other device. For example, a second window may open on a primary game screen (and/or any other display and/or any other output device) that offers a wager on the outcome of the next game (e.g., spin, etc.). In one example, the wagering option may be whether the next game (e.g., spin, etc.) will be a winner or a loser. The player may make the wager and play the game. If the results of the game play is consistent with the player's bet, the player wins and is awarded a prize. In one example, the gaming system does not determine the outcome of the future game play before the wager and/or odds are accepted and/or created. In this example, this gaming option may not need to be approved as a gaming device and may not be subject to the rigorous standards of a regulated gaming device. In this example, an accounting system that accepts bets and pays winning bets may be utilized. In these examples, the player is betting on some characteristic of slot machine play and/or another verifiable event outcome.

In one example, the types of wagers that can be accepted are not relegated to the outcomes of the player's slot machine. In various examples, the possibilities for betting options are related to the events and/or occurrences that can be observed, recorded, and/or verified by the system. For example, one wagering option may be whether the progressive will be hit in the next 3 minutes and/or next 10 spins. In another example, one wagering option may be whether another person (e.g., a friend, a wife, a husband, a stranger, etc.) will win on the next spin. In this example, a loyalty card (and/or some other identification method) may be utilized to identify the player and/or a specific gaming device identification number may be utilized. In another example, one wagering option may be whether the mystery progressive will be hit (e.g., won) before it reaches a certain number (e.g., $300, $1,000, etc.).

In another example, the credits for the wager and the winnings may be moved to and from the primary gaming device through automatic fund transfer (“AFT”) transactions from the system. Further, the system may act as the book maker for the bets. The system may meter and account for all transfers in total and by each game in which pseudo wagers have been made.

In another example, the system may determine the one or more event outcomes via SAS communications, communications with a class II server, and/or other communication protocol and/or other forms of communication methods. The system may record one or more outcomes for the wager and relays the results to the player and/or one or more EGMs. In addition, the system may allow for a ticket to be printed as a pseudo wager receipt but this may not be necessary as the pseudo wager information is already stored on the system. In addition, in cases where the pseudo wager cannot be completed, the pseudo wager may be returned to the player or to the player's account. In various examples, one or more rules may be implemented for pseudo wagers that depend on an event occurring over a time period and/or as other events happen to prevent the player from trying to cancel wagers as a limit is approached. For example, a player may want to cancel a bet that the next four spins will be winner once the second spin was not a winner. However, the system may not allow this.

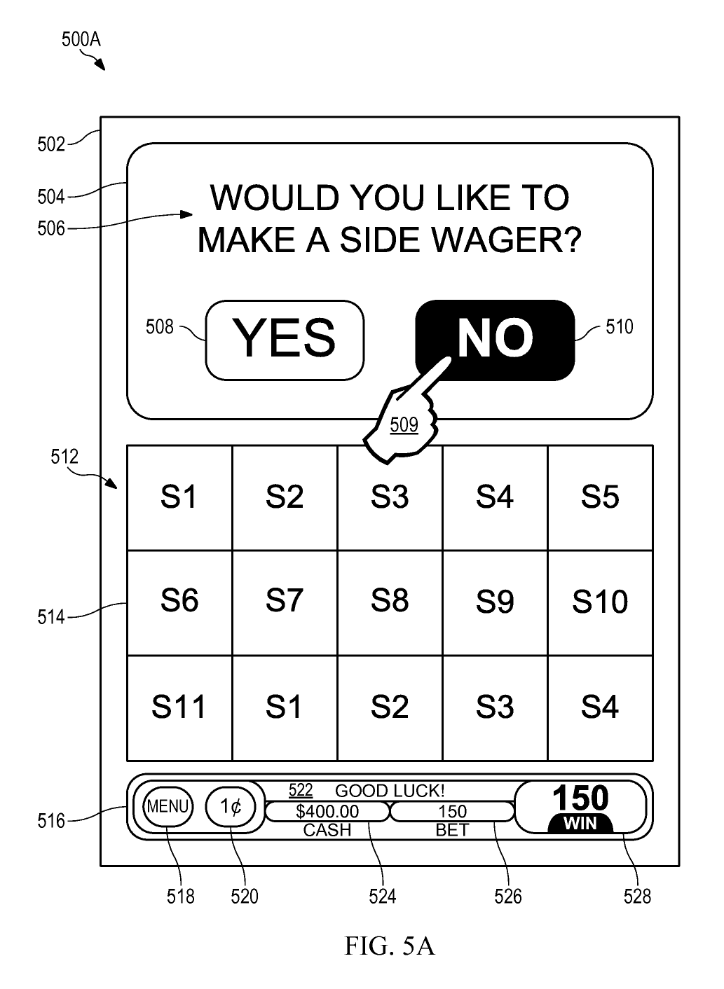

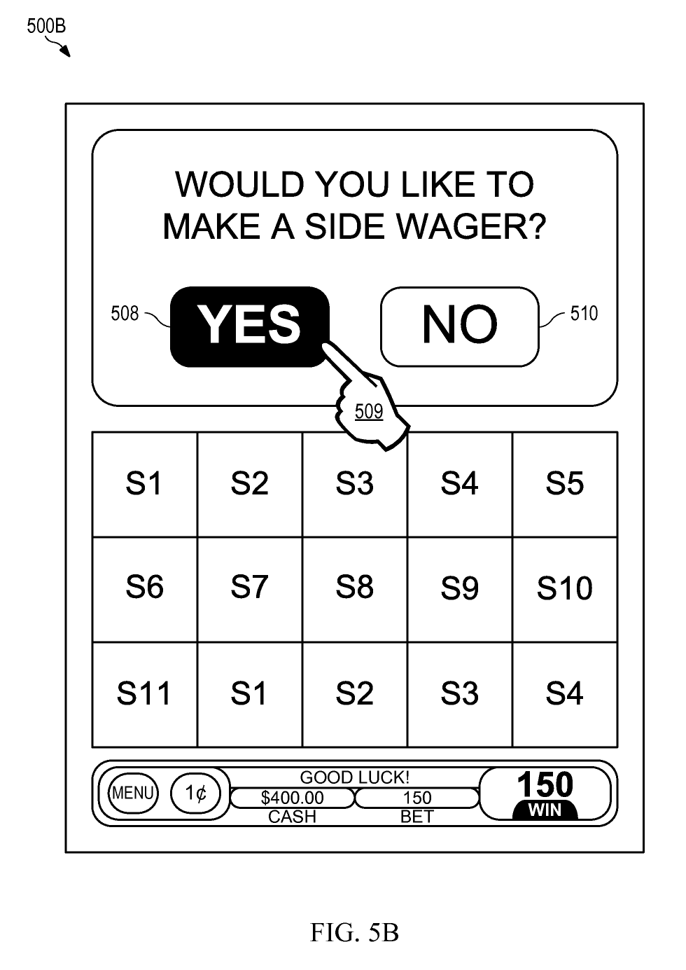

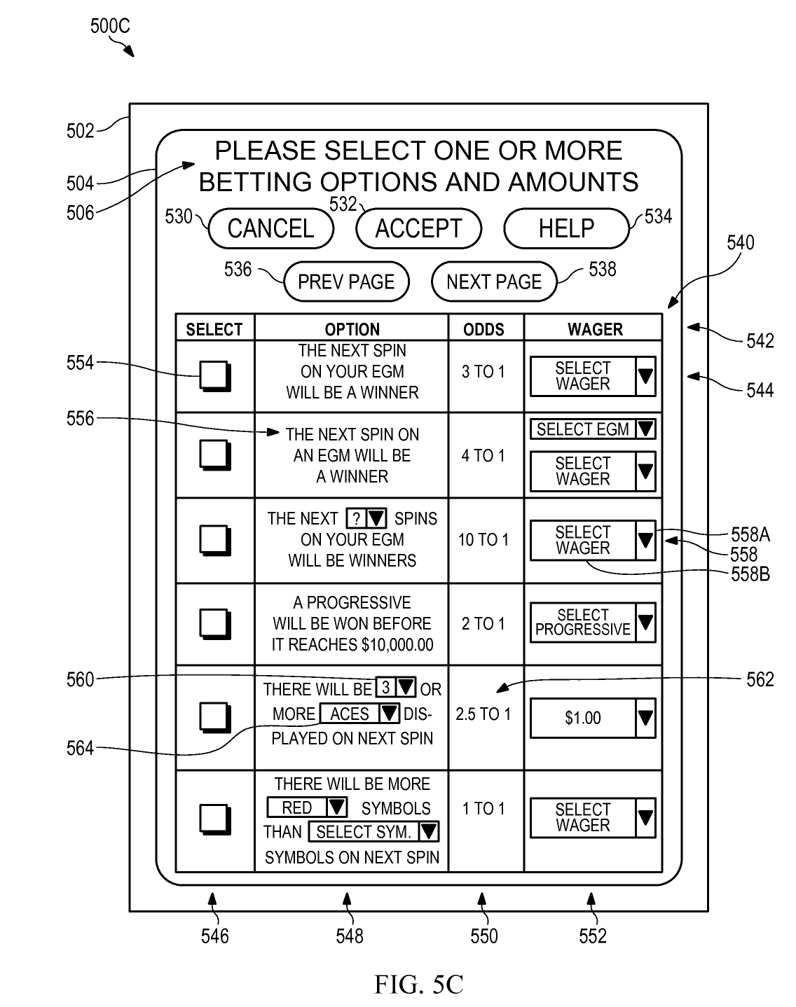

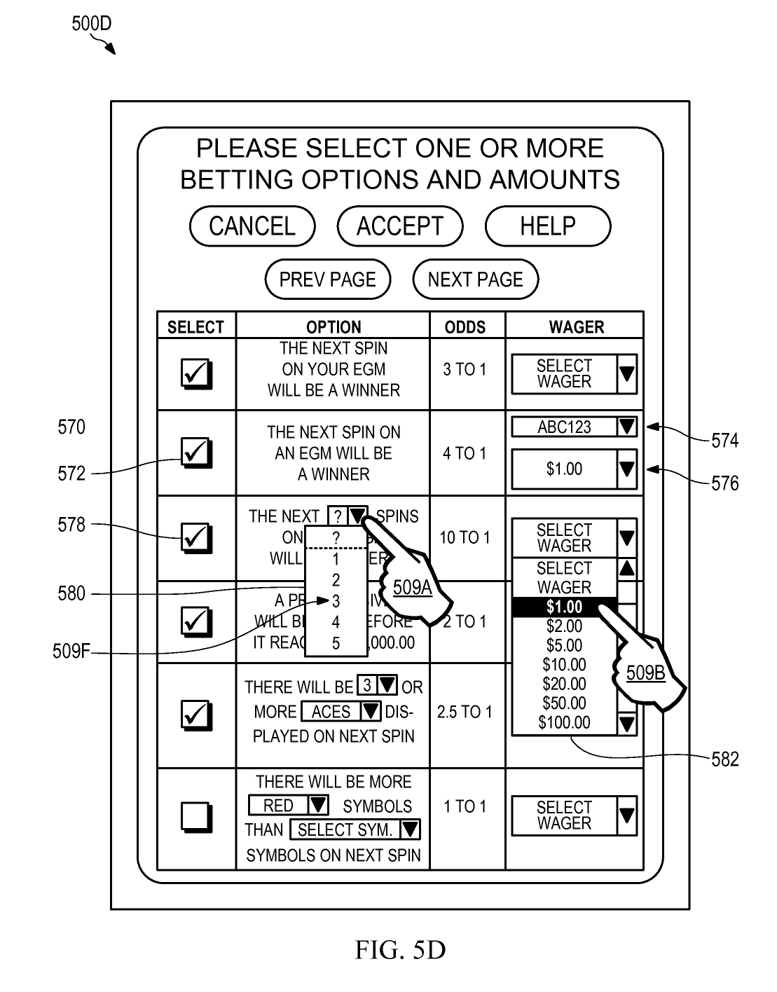

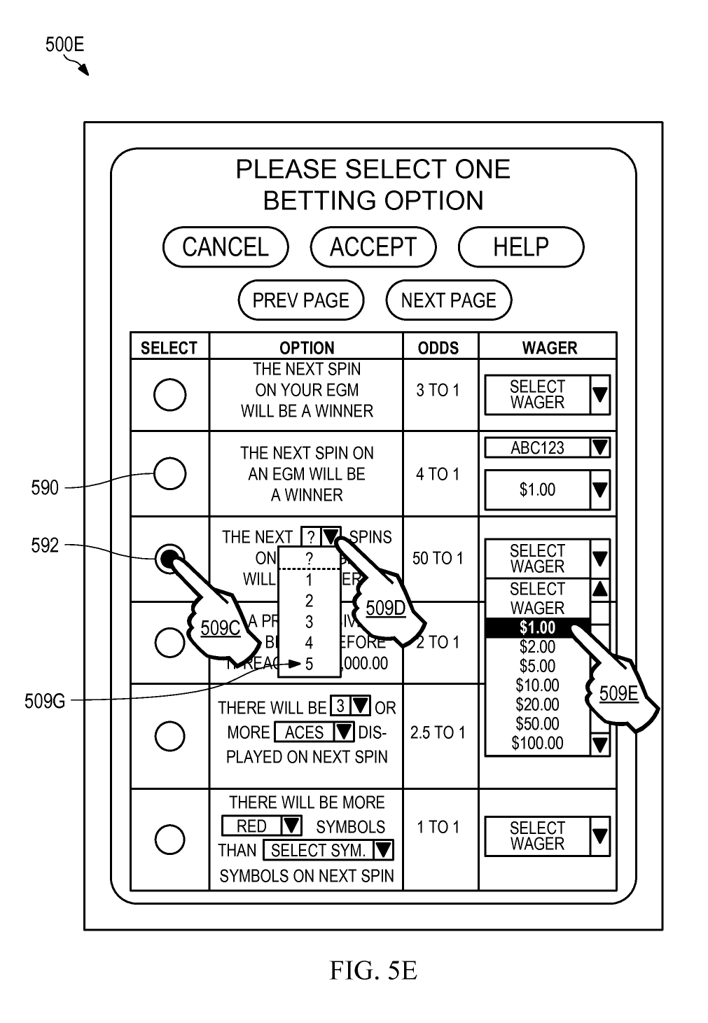

In FIG. 5A, an illustration of pseudo game play on a gaming device 500A is shown, according to one embodiment. A first image 500A may include a display screen 502, a message area 504, a message 506, a first selection option 508, a second selection option 510, an Nth selection option (not shown), a reel area 512, one or more reels 514, a game data area 516, a menu button 518, a bet increment button 520, a game data message area 522, a balance area 524, a bet amount area 526, and an outcome area 528.

In an example, message 506 may request the player to select whether the player would like to make a side and/or pseudo gaming wager. Message 506 may state “WOULD YOU LIKE TO MAKE A SIDE AND/OR PSEUDO WAGER?” In one example, a player may select a pseudo wagering option by selecting first selection option 508 (e.g., Yes—see FIG. 5B). In another example, the player may select to decline making a pseudo wager and/or side bet (e.g., No).

In one example, a pseudo gaming wager is a wager on an event outcome which is a derivate of slot machine play and/or a monetary game play. For example, a wager may be placed on the number of red symbols which will stop on one or more reels during a specific spin (e.g., next spin, third spin from now, etc.). In this example, the electronic gaming machine would not determine how many red symbols are going to stop on the one or more reels during this specific spin before the wager is accepted and/or the odds are generated. Therefore, in this example, this pseudo wager is not based on normal slot machine outcomes (e.g., has a bonus been generated, do the symbols generate a winning payline, winning combinations are based on the random number generator, are regulated outcomes, etc.). For example, a player may make a pseudo wager that the next spin will have at least three winning outcomes (e.g., three winning events, three winning paylines, two winning paylines and one winning scatter, etc.).

In another example, a pseudo gaming wager is a wager on an event outcome which is not related to slot machine play and/or a monetary game play. For example, a pseudo wager may be based on the outcome of a football game, a horse race, and/or any other trackable and verifiable event outcome. The tracking and the verifying may be implemented via one or more electronic devices and/or one or more processors. In one example, a player may wager $100 that the Atlanta Falcons will cover the 7½ point spread versus another team. In this example, as long as the game has not ended (e.g., the final outcome being known), a player may complete this wager. In one example, the wager may pay 1 to 1 (minus any fees) if the game has not started yet. In another example, the wager may pay 10 to 1 if the game only has 2 minutes left and Atlanta is losing by 10 points. In this example, the Falcons would have to score 11 points in 2 minutes. Therefore, if a player wants to initiate this wager at this time, the odds reflect the probability (e.g., extremely low) that Atlanta will be able to score 11 points in the last 2 minutes of the game. In another example, if Atlanta is up by 20 points with 2 minutes left in the game which insures (e.g., 99.9999999999999% probability) that Atlanta will cover the spread, no new bets picking Atlanta may be initiated. Further, pseudo wager may be cashed in as a winner before the event is over. In one example, cashing in the pseudo wager before the event outcome is completed may be discounted in the cash in value. For example, in the case where $100 was bet on Atlanta to win by the 7½ spread (e.g., the odds where 1 to 1) and Atlanta is up by 20 points with 2 minutes to go in the game a player may win $100 at the conclusion of the game assuming Atlanta holds on to win by the point spread. However, the player may be able to cash in the winning ticket with 2 minutes to go for $95. In another example, Atlanta may only be up by 10 points with 2 minutes to go, which means a field goal (e.g., 3 points) by the opposing team would mean that Atlanta would not cover and the current winning wager would become a losing wager. Therefore, the player may be able to cash in the pseudo wager in this example for $60 which reflects at least a portion of the probability of Atlanta covering the spread. The pseudo wager's value may fluctuate and/or be automatically updated during the entire event. The player may be able to cash in the pseudo wager at one or more electronic gaming devices, one or more central devices, a cashier's desk, via their hotel room TV, and/or any other electronic gaming device, and/or any other electronic device (e.g., cellphone, etc.).

In another example, a pseudo gaming wager is a wager on an event outcome which is not related to slot machine play and/or a monetary game play, along with an event outcome which is a derivate of slot machine play and/or a monetary game play. For example, a player may initiate a pseudo wager that is based on a horse race (e.g., horse 1 will win race 1) and the next three spins will each have at least one winning outcome.

In FIG. 5C, another illustration of pseudo game play on a gaming device is shown, according to one embodiment. A second image 500C may include display screen 502, message area 504, message 506, a cancel button 530, an accept button 532, a help button 534, a previous page button 536, a next page button 538, a wager selection area 540, one or more selection options 554, a column header area 542 (e.g., a first selection criteria 546 (e.g., a selection input), a second selection criteria 548 (e.g., an option description), a third selection criteria 550 (e.g., odds-payout rate, etc.), a fourth selection criteria 552 (e.g., a wager), etc.), one or more wagering options 544, one or more wagering option descriptions 556, a drop down selection button 558 (with a drop down arrow 558A and one or more wagering selections 558B, a number selection button 560, a symbol selection button 564, a color selection button, a person selection button, a comparison symbol selection button, and an odds description 562.

In one example, cancel button 530 may be selected by the player to cancel one or more transactions. In another example, accept button 532 may be selected by the player to confirm one or more transactions. In another example, a player may select help button 534 to obtain information and/or obtain a live help function (e.g., a live operator to assist in completing one or more transactions, to provide information, and/or to trouble shoot one or more problems). In another example, previous page button 536 may be selected by the player to move back to one or more previous pages. In another example, next page button 538 may be selected by the player to move forward to one or more pages.

In one example, a pseudo wager option may be whether the next spin on your EGM will be a winner. In this static example, the specific spin may not be able to be changed. The only item the player may change is the wager amount (see the first wagering option in FIG. 5C). In another example, a dynamic mode may be utilized where the player can select a specific future spin to wager on (e.g., the tenth spin from now) (see the third wagering option in FIG. 5C). Further, in the dynamic mode option, the odds, wager limits, and/or any other criteria of the wagering options may be modified based on any selection by the player. For example, the player may change the odds (e.g., only wants 5 to 1 betting options); therefore, only pseudo wagering options with 5 to 1 odds would be displayed. Further, the player may also want to see any pseudo wagering options with at least a certain odds (e.g., 10 to 1). In this example, all wagering options with at least a 10 to 1 odds ratio would be displayed. In another example, there may be wagering limits placed on any pseudo wagering options. For example, a thousand to one odds wagering option may be limited to a maximum bet of $1000 so that no payout is higher than a certain number (e.g., $1,000,000, etc.). In another example, there may be no wagering limitations.

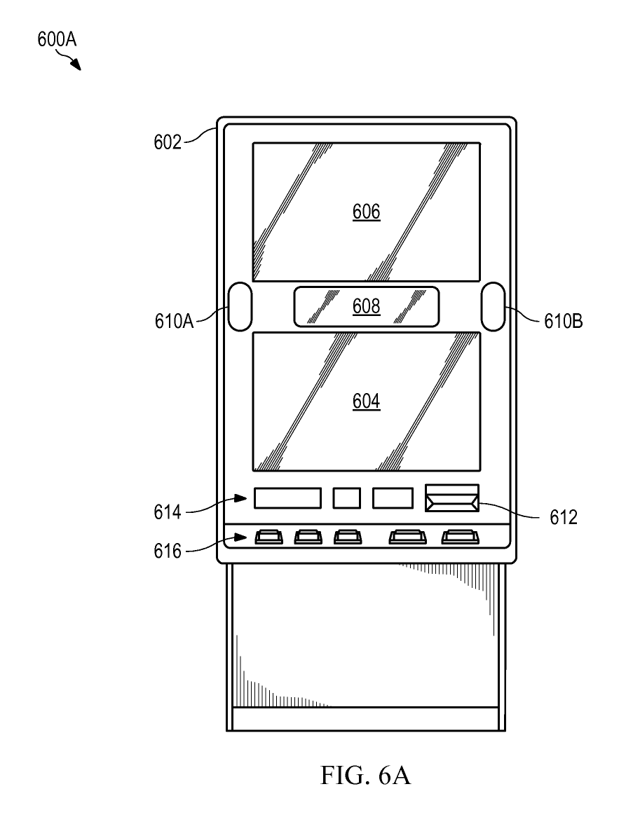

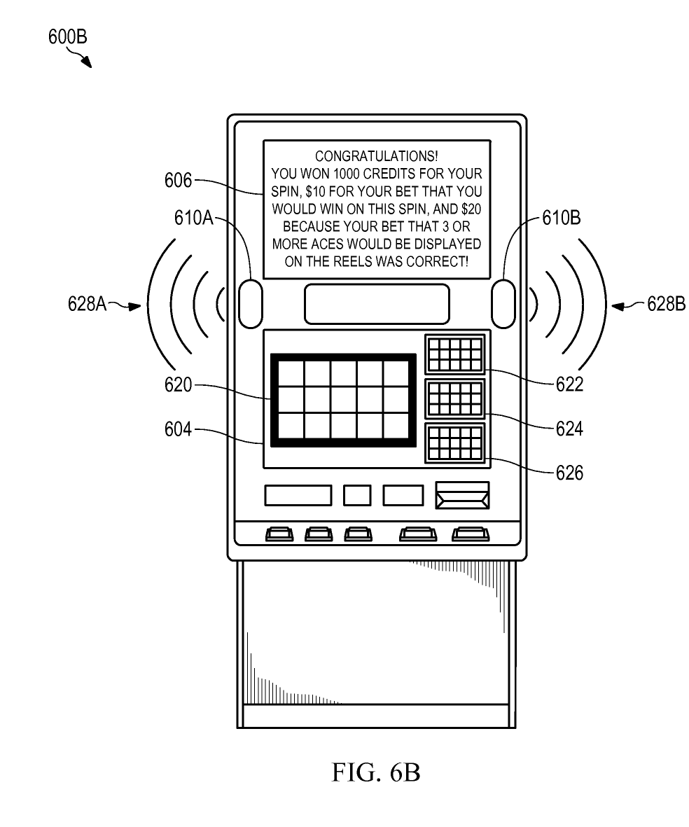

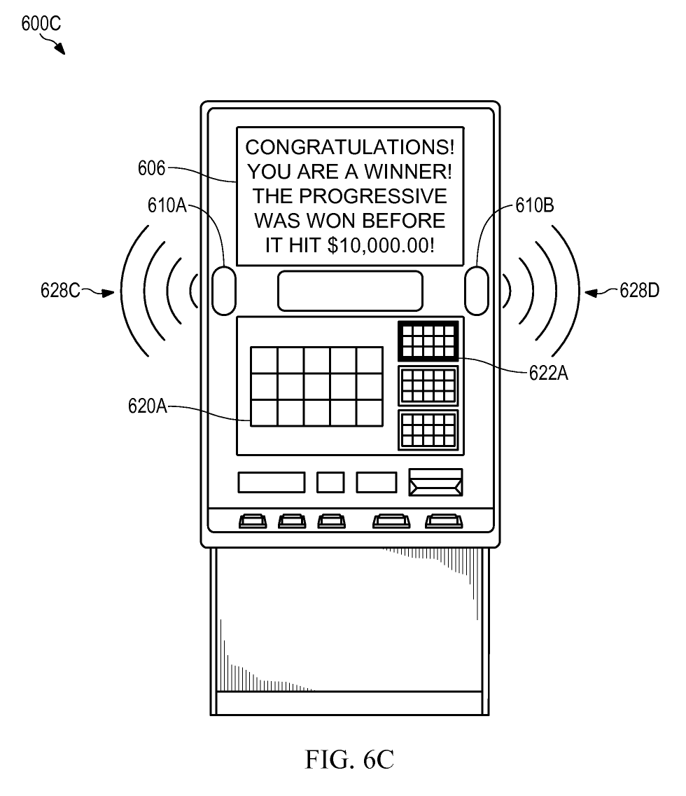

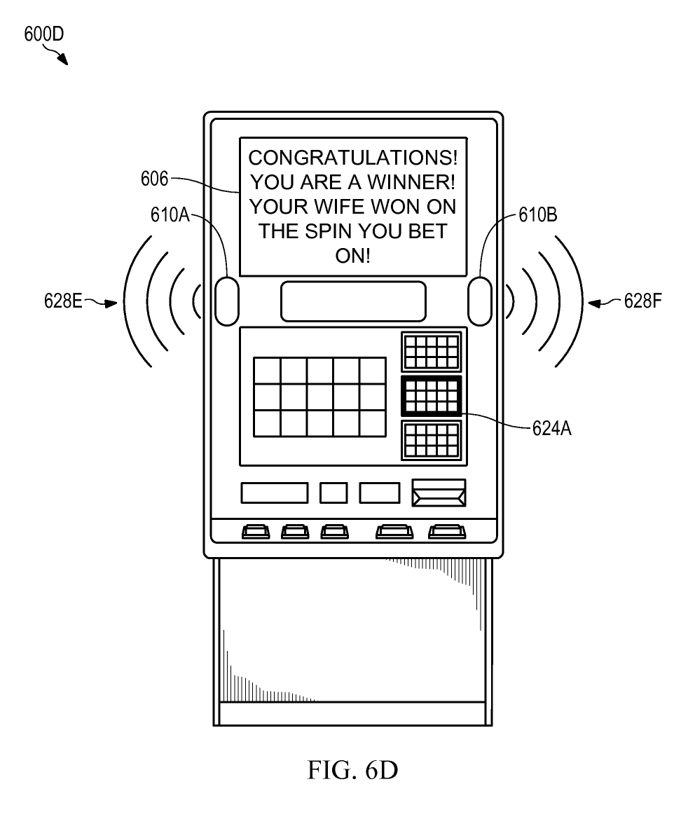

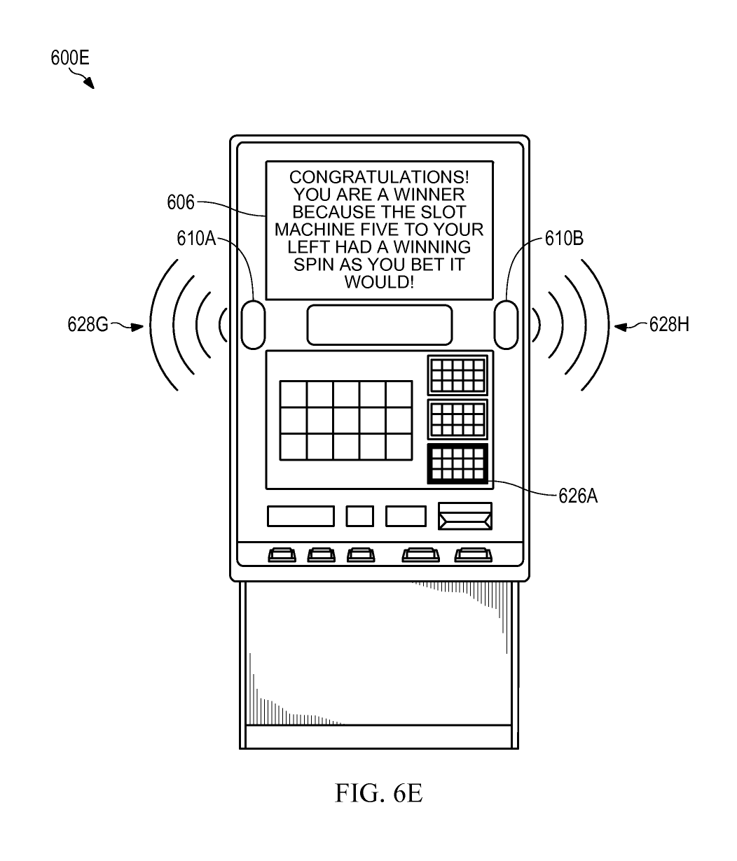

In another example, the player may select any electronic gaming machine (“EGM”) to wager on and/or any event relating to this specific EGM (see the second wagering option on FIG. 5C) to wager on. In one example, the EGM may be an EGM identified by a player's card (e.g., the EGM that the husband is currently playing on, the EGM that the son is currently playing on, the EGM that the wife is currently playing on, the EGM that the friend is currently playing on, etc.). In another example, the player may select any EGM (e.g., the one right next to the player, EGM numbered 0129340, EGM numbered 2183048, the EGM that has won the most in the last 5 spins, the EGM that has not won in the last 10 spins, etc.). The player may view any EGM on one or more screens on their EGM (see FIG. 6B reference numbers 622, 624, and 626). The player may view any EGM before making a wager to try to obtain some gaming history (e.g., the last 5 spins have been winner, during the last 10 spins the winning percentage is 30%, etc.). In another example, the player may view any EGM that the player has made a wager on. Further, the player may obtain historical data (e.g., spin by spin data for X numbers of historical spins, the average win rate (e.g., ⅓ of the spins are winners, ⅔ of the spins are winners, etc.), the last win over $1,000 was done on X date.

In another example, the player may make a pseudo wager on when one or more progressives will be hit. For example, the player may initiate a pseudo wager that the XYZ progressive will be hit before it reaches $10,000 (see the fourth wagering option on FIG. 5C). In another example, the player may initiate a pseudo wager that the ABC progressive will be hit before 10,000 spins relating to the ABC progressive have be completed. In another example, the player may initiate a pseudo wager that the 123 progressive will be hit before 15,000 spins and before it reaches $50,000.

In another example, the player may initiate a pseudo wager on a specific number of specific symbols stopping in one or more active reels areas during a specific spin. In one example (see the fifth wagering option on FIG. 5C), a pseudo wagering option may be that 3 (and/or any number from 0 to N) Aces (and/or any other symbol and/or combination of symbols (e.g., 3 Aces, 2 Kings, and 3 stars, etc.) are part of the final outcome of a gaming event (and/or any intermediate step (e.g., bonus round, first part of a game play, etc.)).

In another example, a pseudo wagering option may be that there will be more of a first symbol (and/or combination of symbols (e.g., Ace and a King, etc.) than a second symbol (and/or combination of symbols (e.g., Jack and Star) in a final position, an intermediate position, and/or any other position (e.g., bonus game).

In FIG. 5D, another illustration of pseudo game play on a gaming device is shown, according to one embodiment. In an image 500D, the player has selected five wagering options as can be seen by the check marks in the first five selection options (e.g., the next spin on the player's current EGM will be a winner which would pay 3 to 1; the next spin on the ABC123 EGM will be a winner which would pay 4 to 1 and the player bet $1; the next 3 spins on the player's current EGM will be winners which pays 10 to 1 and the player has bet $1; the progressive will be won before the progressive hits $10,000 which pays 2 to 1; and there will be 3 or more Aces displayed on the next spin when the spinning stops). In one selection represented by reference number 572, the player has elected to wager that the next spin on a specific electronic gaming machine (“EGM”) will be a winner. The odds are 4 to 1 for this wagering option. Further the player has elected the ABC123 EGM as can be seen by an EGM selection button 574. In addition, the player has elected to wager $1 as shown by a wager selection button 576. Any EGM and/or any wagering amount may be utilized.

In another selection represented by reference number 578, the player has elected to wager that the next 3 spins (via a firsthand movement 509A and a second hand movement 509F) on the EGM that the player is currently playing on will be winners. These selections were on a spin selection drop down menu 580. The odds are 10 to 1 for this wagering option. Further, the player has elected to wager $1 (via a third hand movement 509B) as shown by a drop down wagering window 582.

In FIG. 5E, another illustration of pseudo game play on a gaming device is shown, according to one embodiment. In this example, the player may elected one or more wagering options via one or more radial buttons 590. In this example, the player has selected a first wagering option via a first radial button selection 592. In this example, the player has selected (via a fourth hand movement 509D and a sixth hand movement 509G) to wager that the next 5 spins on their EGM will be winners. The odds for this wagering selection are 50 to 1. Further the player has wagered $1 on this option (via a seventh hand movement 509E).

In one example, a pseudo wager may be that the next 5 spins on the player's current EGM will be winners which pay 50 to 1. In this example, the player had seven bet amount choices (however, any number may be utilized) which were $1, $2, $5, $10, $20, $50, and $100.

In FIG. 6A, another illustration of pseudo game play on a gaming device is shown, according to one embodiment. A gaming device 602 may include a leaderboard display 606, a side display 608, a main game display 604, a left speaker 610A, a right speaker 610B, one or more output devices (e.g., a ticket in/ticket out device 612), and/or one or more input devices 616 (e.g., buttons, etc.). In one example, leadership display 606 includes a leadership board sponsor and a ranking of tournament players. In this example, the XYZ company has sponsored the leadership board and the leadership board states “XYZ LEADER BOARD.” In another example, leadership display may include data relating to one or more tournaments, such as, the time remaining (e.g., 1 HOUR 31 MINUTES REMAINING). In this example, side display 708 may display a current mode of operation. For example, a current mode may be a tournament mode, a normal mode, a practice mode, a team mode, an individual mode, any combination thereof, etc.

In FIG. 6B, another illustration of pseudo game play on a gaming device is shown, according to one embodiment. A pseudo gaming image 600B may include a message area 606A, a first sound message 628A, a second sound message 628B, a first gaming area 620, a second gaming area 622, a third gaming area 624, and an Nth gaming area 626.

In one example, a message in message area 606A may state “CONGRADULATIONS! YOU WON 100 CREDITS FOR YOUR SPIN, $10 FOR YOUR BET THAT YOU WOULD WIN ON THIS SPIN, AND $20 BECAUSE YOUR BET THAT 3 OR MORE ACES WOULD BE DISPLAYED ON THE REELS WAS CORRECT!”

In another example, a pseudo wagering option may be that there will be more of one symbol (e.g., red, warriors, etc.) than another symbol (e.g., black, zombies, etc.). In another example, a pseudo wagering option may be that there will be more of one symbol combination (e.g., warrior and ships) versus another symbol combination (e.g., bases and planes).

In another example, a pseudo wagering option may be that there will be an Ace (and/or any other symbol) in a predetermined location (e.g., first row and first column). In another example, a pseudo wagering option may be that there will be a first Ace (and/or any other first symbol) in a first predetermined location (e.g., first row and second column) and a second Ace (and/or any other second symbol) in a second predetermined location (e.g., third row and fifth column).

In another example, a pseudo wagering option may that a certain number of symbols with one or more specific characteristics (e.g., HEARTS, star, male, female, wild, scatter, etc.) will be displayed when the spin is completed. For example, a pseudo wagering option may be that a certain number of wild symbols will be displayed when the spin stops. In another example, a pseudo wagering option may be that a certain number of scatter symbols will be displayed when the spin stops. In another example, a pseudo wagering option may be that a certain number of expanding wild symbols will be displayed when the spin stops

In another example, a pseudo wagering option may be that a certain portion of the game (e.g., BONUS GAME, etc.) will be initiated during a certain spin and/or spin duration (e.g., over the next X spins) and/or time duration. In another example, a pseudo wagering option may be that a certain number female players will win during a certain time frame. Further, the pseudo wagering option may be that more female players will win versus male players, or vice versa during a certain spin, range of spins, group of spins, and/or time duration.

In another example, a pseudo wagering option may be that a specific amount and/or an amount range will be won during a specific spin and/or range of spins (e.g., 1 to N). For example, a pseudo wager may be placed that predicts that $0-$5 (or $5.01 TO $10, $10.01 to $20.00, etc.) will be won on the next spin (and/or any spin and/or any time duration). Further, the pseudo wager may be that exactly $5.00 will be won on a spin. In addition, a range of spins may be selected. For example, on spins 3-5, $0-$5 (and/or $4 exactly) will be won. In another example, on spins 3, 5, and 10, $0-$5 (and/or $4 exactly) will be won.

In another example, a pseudo wagering option may be based on a lack of symbols being displayed when the reels stop spinning (e.g., the completion of a spin). In one example, the player may wager that no stars will be displayed at the completion of a spin. Depending on the frequency of the selected symbol, the odds for these wagers will be adjusted. In another example, the pseudo wagering option may be that there will be no stars and no aces when the reels stop. Any number (1-N) of symbols may be utilized. In another example, a pseudo wagering option may be that there will be no stars and no aces but a bar symbol and a king symbol will be present at the end of the spin. Further, a pseudo wagering option may be that there will be no stars and no aces but 2 bar symbols and 5 king symbols will be present at the end of the spin.

In another example, a pseudo wagering option may be that there will be a special symbol (e.g., scare number) displayed. For example, there may only be one Ace of hearts and the player may wager that this symbol will be displayed at the completion of a spin (and/or a spin range and/or duration period).

In another example, a pseudo wagering option may be that one or more symbols are located in one or more columns and/or rows. For example, a player may wager that an Ace will be (and/or not located) located in row 1. In another example, the player may wager that an Ace will be (and/or not located) located in column 4. In another example, the player may wager that an Ace will be (and/or not located) located in both row 1 and column 4 (and/or any number of aces will be in any number of rows and/or columns). Further, the player may wager that an Ace will be located (and/or not located) in row 2 and a King will be located in column 4. Further, the player may wager that an Ace will be located (and/or not located) in row 4, a King will be located (and/or not located) in row 3, and a Queen will be located (and/or not located) in both row 1 and column 1. Any combination of symbols (e.g., 1-N) and any combination of locations (row 1, column 1, row 2, etc.) may be utilized.

In another example, a pseudo wagering option may be based on obtaining X number (e.g., 1-N) of wins on Y EGM (and/or a group of EGMs) on the next spin (and/or a range of spins (e.g., spins 3-5) and/or a grouping of spins (e.g., spin 1, spin 3, and spin 8). In one example, the player may wager that on the next spin of the EGM that there will be 4 winning paylines. In another example, the player may wager that during spin 1, spin 3, and spin 8, 10 winning paylines will be formed (and/or 8 winning paylines and 2 scatter payouts, etc.). In another example, the player may make a pseudo wager that payline number 7 will win on the next spin, will win within the next three spins, will win 3 times during spin 1, spin 3, and spin 8, etc.

In another example, a time element may be utilized and/or combined with any other option. For example, the player may initiate a pseudo wager that the next win on Y EGM will occur within 2 minutes (and/or any other timeframe). In another example, the player may place a pseudo wager that 3 winning paylines will form in the next 2 minutes (and/or any other time period). Further, another wagering option may be that payline 5 will be a winning payline within the next ten minutes. In addition, the player may wager that paylines 1, 4, 5, and Nth will all be winning paylines within the next 10 spins and/or the next 5 minutes. In another example, a player may wager that payline 7 will win more times than payline 5 for one spin, a few spins, a plurality of spins, a range of spins, a group of spins, and/or for any time duration.

In another example, a pseudo wagering option may be when one or more multipliers will be generated, displayed, and/or won. For example, a player may wager that a multiplier will be won on the next spin (and/or a range of spins and/or a grouping of spins). In another example, the player may wager that 2 (and/or any other number) of multipliers will be won on the next X spins (and/or range and/or groupings of spins). In another example, a wager may be placed that a multiplier may not be displayed during a spin, a few spins, and/or a time duration.

In another example, a pseudo wagering option may be that X dollars will be won on the next (or any specific free spin) free spin(s) (and/or range of free spins and/or groupings of free spins). For example, a pseudo wager may be that $10 or more will be won on the next free spin game. In another example, the pseudo wager may be that $10 or less will be won on the next free spin game. In another example, a wager may be placed that $50 will be won during the next three free spin games (e.g., in the first free spin game there may have been 5 free spins, during the second free spin game there may have been 3 free spins, and during the third free spin game there may have been 10 free spins). In another example, the pseudo wager may be that a free spin game will be initiated during the next 10 spins and that $25 or more will be won in this initiated free spin game.

In another example, the pseudo wager may be that the next bonus game will be initiated in the next 7 minutes and the amount won during this bonus game round will be X (any amount, any range, etc.) dollars.

In another example, the pseudo wager may be based on the number of losses and/or number of wins in a row. In one example, the pseudo wager may be that a specific EGM will have 2 losses in a row and/or 2 wins in a row. For example, this EGM will have 2 losses, then 1 win, then 3 loses, and then 5 wins. Any pattern may be the basis for a pseudo wager.

In another example, one or more random elements of game play may be the basis for a pseudo wager. For example, the next song played by the EGM will be X, the third song with be Y, a random character (e.g., a pirate, etc.) will be displayed on an animated screen during the next spin, within 5 minutes, etc.

In another example, the pseudo wager may be based on two or more symbols occurring in a certain order. For example, a pseudo wager may be based on two Aces occurring adjacent to each other. In another example, the wager may be based on an Ace symbol being next to a King symbol which is next to a Queen symbol which is next to a Jack symbol which is next to a Ten symbol. These patterns may be horizontal, vertical, in a T shape, an S-shape, an L-shape, an O-shape, and/or any other shape (e.g., X, Z, etc.). In another example, the wager may be based on forming a certain percentage of the formation. For example, in the Ace to Ten example discussed about, a wager may be that 4 out of 5 symbol will occur (or at least 4 symbols, or at least 3 symbols, etc.). In this example, if one of the symbols is missing, the player still wins (e.g., the Ace is adjacent to the King which is adjacent to the Queen, and the Ten is within 2 spots of the Queen, etc.).

In another example, the pseudo wager may be based on no one winning and/or losing for a certain amount of spins (e.g., 1, 2, . . . etc.). In this example, the player may wager that no one in the casino will win on their next slot machine spin and/or that everyone in the casino will win on their slot machine spins. Further, the slot machines may be segregated. For example, a group of slot machines may be utilized (e.g., a first bank, a first row, a second bank, a second row, a first column, etc.). In this example, the player may wager that all of the EGM in the bank and/or row and/or any other segmentation will all win and/or all lose during the next spin (e.g., and/or a group of spins and/or a range of spins and/or during a time period). Further, the wager may be that a certain percentage (e.g., 0 to 100%) of the games of these EGMs will win and/or lose. In one example, the player may wager that 51% (or more) of the EGM will have winning outcomes.

In another example, the pseudo wager may be based on the outcome of another event (e.g., a football game, a soccer game, a horse race, a basketball game, a baseball game). These outcomes may also include point spreads. For example, the Atlanta Falcons will win by 7½ points over another team. In another example, a player may wager that he will win over $100 on one or more EGMs in the next hour and that the Falcons will win and/or cover the spread (e.g., 7½ points) in X football game.

In another example, the pseudo wager may be that the Dow Jones will go up and/or down by 100 points today and/or by a certain percentage. Further, the player may wager that the DOW will go down by 200 points today, a specific stock will go up by 5%, and the player will lose X dollars playing one or more EGM today (and/or in a specific time frame). In this example, the player may be hedging because they own stock and/or are shorting stocks. The player may wager that they will lose $100 today.

In another example, the pseudo wager may be based on X tournament (E.G., POKER, GOLF, ETC.) being won by X. In one example, a player may wager that X will win a golf tournament, a poker tournament, a slot tournament, etc. In another example, the player may wager on themselves winning a slot tournament, a blackjack tournament, a poker tournament, etc.

In another example, the pseudo wager may be based on that the first symbol being X, it will be red, and it will be over a 10. In another example, the exact symbol location and/or range (e.g., four symbol area) may be wagered on.

In another example, the pseudo wager may be based on the first symbol will be X symbol, Y will be the last symbol, and/or any symbol interaction. In another example, X symbol will be four spaces away from Y symbol. In another example, the wager may be based on the first symbol will be an X symbol and the last symbol will not be a Y symbol. This can be utilized with symbol combinations also. The first symbol will be either an A symbol and/or a B symbol while the last symbol will not be a Z symbol, a C symbol, and/or a B symbol.

In another example, the wager may be that there will be no bonus rounds on a specific EGM, a group of EGMs, and/or all EGMs for a certain amount of spins (e.g., 1-N) and/or within a certain time period (e.g., 1 second to 10 years).

In another example, the pseudo wager may be based on no wilds being in column X, Row Y, and/or any other column, row, and/or area. In a blackjack type game, a pseudo wager may be that I will not bust for X hands.

In various examples, the value of the pseudo wager may be automatically undated and/or vary over time. For example, when a player wagers that the next 3 spins (at 10 to 1 odds) will be winners the initial value of the wager is $1. After the first winning spin, the value of the wager may now be $2. After the second winning spin is a winner, the value of the wager may now be $4. After the third winning spin is a winner, the value of the wager may now be $10. If the third winning spin was a loser, then the value of the wager would have been reduced to $0.

In one example, this may be a system based game that can be on any media (e.g., a Pizza box, a piece of paper, a primary game window, a secondary game window, any electronic device, etc.). The pseudo wagering vehicle can accept additional wagers on the primary game and/or on any other events.

In FIG. 6C, another illustration of pseudo game play on a gaming device is shown, according to one embodiment. In a second pseudo image 600C, the message states “CONGRADULATIONS! YOU ARE A WINNER! THE PROGRESSIVE WAS WON BEFORE IT HIT $10,000.00!”

In FIG. 6D, another illustration of pseudo game play on a gaming device is shown, according to one embodiment. In a third pseudo image 600D, the message states “CONGRADULATIONS! YOU ARE A WINNER! YOUR WIFE WON ON THE SPIN YOU BET SHE WOULD WIN ON!”

In one example, the pseudo wager may be placed on an EGM at another casino and/or a gaming machine which is online.

In FIG. 6E, another illustration of pseudo game play on a gaming device is shown, according to one embodiment. In a fourth pseudo image 600E, the message states “CONGRADULATIONS! YOU ARE A WINNER BECAUSE THE SLOT MACHINE FIVE TO YOUR LEFT HAD A WINNING SPIN AS YOU BET IT WOULD!”

In another example, a wager may be that a first EGM will win a first game and then after that a second EGM will win on the very next spin after the first EGM win, and then a third EGM will win on the very next spin after the second EGM win. Any number of EGMs may be utilized and any subsequent spin may be utilized.

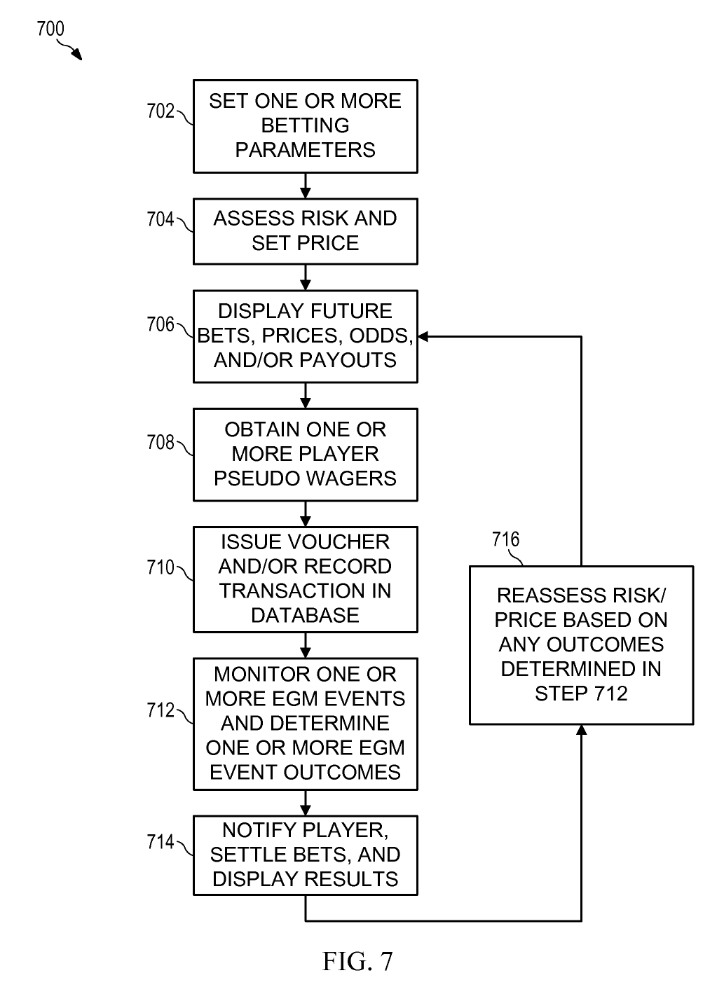

In FIG. 7, a game play flow diagram is shown, according to one embodiment. The method may include setting one or more betting parameters (step 702). The method may include assessing the risk and setting one or more prices (step 704). The method may include displaying one or more future bets, prices, odds, and/or payouts (step 706). The method may include obtaining one or more player pseudo wagers (step 708). The method may include issuing one or more vouchers and/or recording one or more transactions in a database (step 710). The method may include monitoring one or more electronic gaming machine (“EGM”) events and/or determining one or more EGM event outcomes (step 712). The method may include notifying one or more players, settling one or more bets, and displaying one or more results (step 714).

In another example, the method may include reassessing one or more risks and/or prices based on one or more outcomes determined in step 714. The method may then return to step 706.

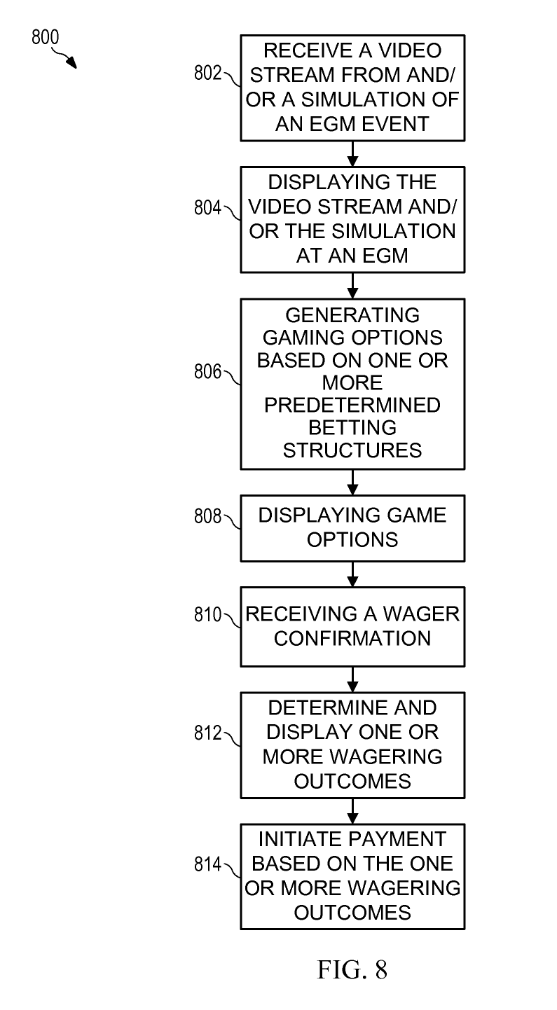

In FIG. 8, a game play flow diagram 800 is shown, according to one embodiment. The method may include receiving one or more video streams from and/or one or more simulations of one or more EGM events (step 802). The method may include displaying one or more video streams and/or one or more simulations at one or more electronic gaming devices (step 804). The method may include generating one or more options based on one or more predetermined betting structures (step 806). The method may include displaying one or more gaming options (step 808). The method may include receiving one or more wager confirmations (step 810). The method may include determining and displaying one or more wagering outcomes (step 812). The method may include initiating one or more payments based on the one or more wagering outcomes (step 814).

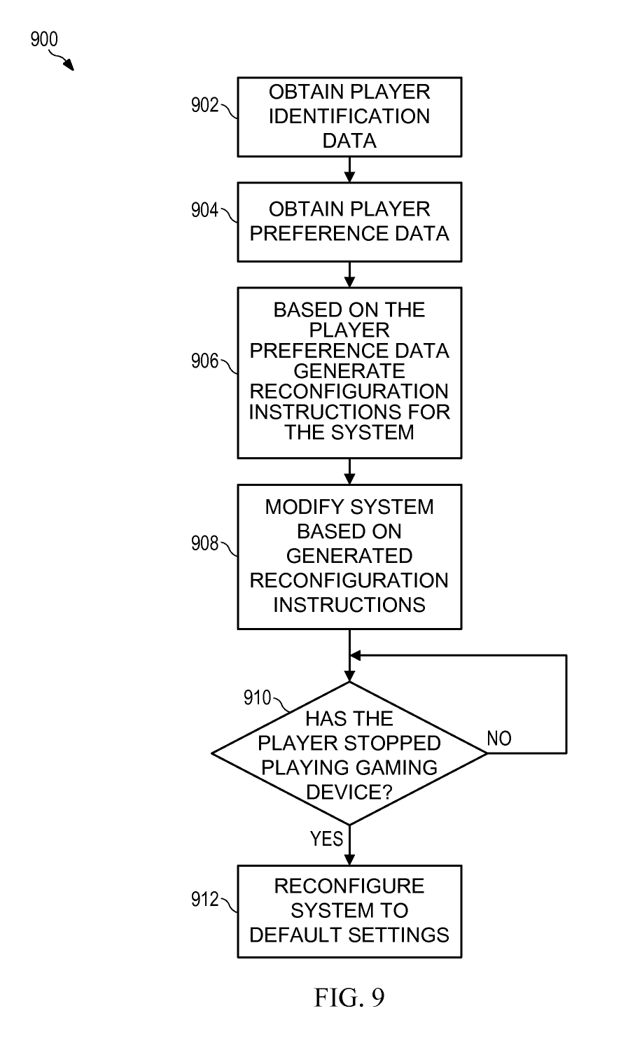

In FIG. 9, a game play flow diagram 900 is shown, according to one embodiment. The method may include obtaining player identification data (step 902). The method may include obtaining player preference data (step 904). The method may include generating reconfiguration instructions for the system based on the player preference data (step 906). The method may include modifying the system based on the generated reconfiguration instructions (step 908). The method may include one or more processors (via the electronic gaming device and/or the electronic gaming system) determining whether the player has stopped playing the gaming device (step 910). If the player has not stopped playing the gaming device, then the method may return to step 910. If the player has stopped playing the gaming device, then the method may include reconfiguring the system and/or gaming device to one or more default settings (step 912).

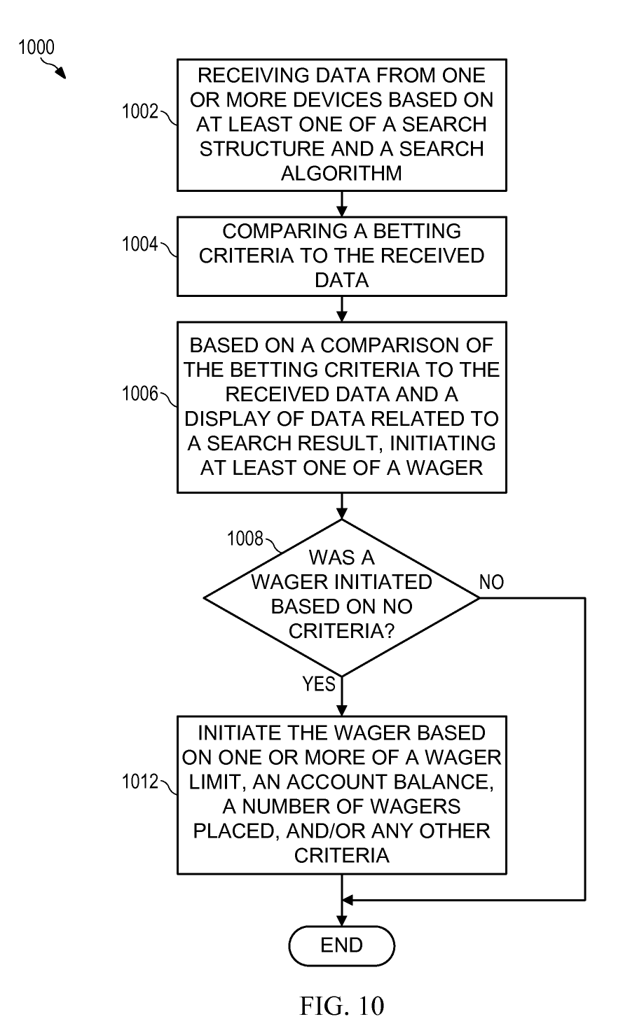

In FIG. 10, a flow diagram for game play 1000 is shown, according to one embodiment. The method may include receiving data from one or more devices based on at least one of a search structure and/or a search algorithm (step 1002). The method may include comparing a betting criteria to the received data (step 1004). The method may include based on a comparison of the betting criteria to the received data and a display of data relating to a search result, initiating at least one wager (step 1006). The method may include via one or more processors determining whether a wager was initiated based on one or more future criteria and/or one or more criteria (step 1008). If no wager was initiated, then the method may end. If there was one or more wagers placed and/or future wagers, then the method may initiated the wager based on one or more of a wager limit, an account balance, a number of wagers placed, and/or any other criteria (step 1012).

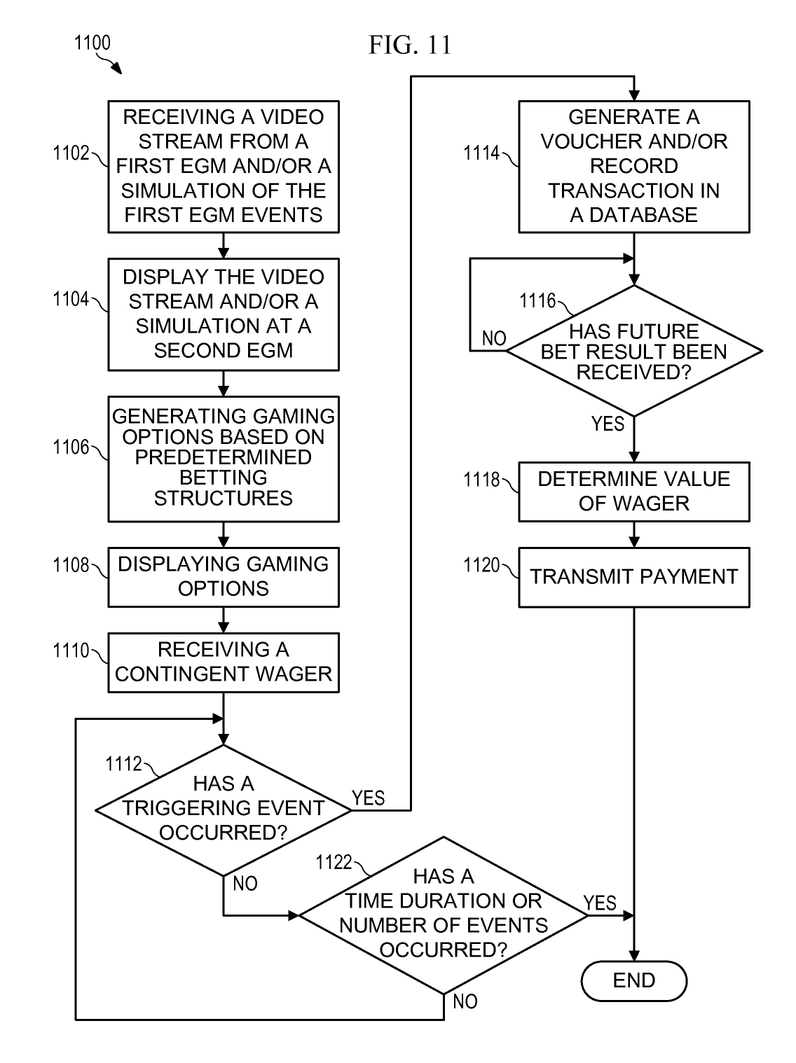

In FIG. 11, a flow diagram for game play 1100 is shown, according to one embodiment. The method may include receiving one or more video stream from a first EGM and/or one or more simulations of one or more first EGM events (step 1102). The method may include displaying one or more video streams and/or one or more simulations at a second EGM (step 1104). The method may include generating gaming options based on predetermined betting structures (step 1106). The method may include displaying gaming options (step 1108). The method may include receiving a contingent wager (step 1110). The method may include via one or more processors determining whether a triggering event has occurred (step 1112). If no triggering event has occurred, then the method may determine whether a time duration or number of events has occurred and/or elapsed (step 1122). If the time duration has not elapsed and/or a number of events has not occurred, then the method may move back to step 1112. If the time duration has elapsed and/or a number of events have occurred, then the method may end. If a triggering event has occurred, then the method may generate a voucher and/or record the transaction in a database (step 1114). The method may determine whether the future bet result has been received (step 1116). If the future bet has not been received, then the method may return to step 1116). If the future bet has been received, then the method may determine the value of the wager (step 1118). The method may include transmitting payment (step 1120).

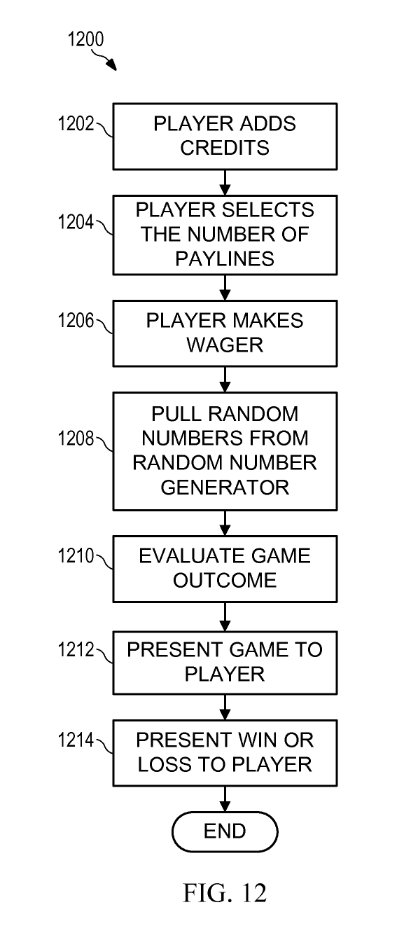

In FIG. 12, a process flowchart of one example of a primary game play 1500 on an electronic gaming system is shown, according to one embodiment. The method may include the step of a player adding credit to the electronic gaming system (step 1202). It is contemplated that a player can do this by inserting cash, coins, a ticket representative of a cash value, a credit card, a player card, requesting an electronic funds transfer (“EFT”), otherwise requesting access to an account having monetary funds, and/or any combination thereof.

At step 1204, the player selects the number of paylines to play. In one embodiment, the player can select from a plurality of different paylines to play. In a further embodiment, the player can only play a predetermined number of paylines. An example of this embodiment may be the instance where the gaming system only allows a player to play forty paylines, and cannot select to play more or less paylines. In another embodiment, the gaming system does not offer paylines, but rather offers a different way to evaluate the game play. One example of a different way may be sometime referred to as a 243-ways evaluation, where symbols may be evaluated based on the existence of like-symbol clusters on adjacent reels, starting with the left-most reel and continuing right, instead of how many paylines run through the like-symbol clusters.

At step 1206, the player makes a wager on the game. In one embodiment, the wager may be a multiple of the number of paylines selected at step 1204. In another embodiment, the wager may not be a multiple of the number of paylines selected at step 1204. In a further embodiment, the wager may include a side-wager (e.g., ante bet), which may, in one example of such an embodiment, be used to make the player eligible to be awarded the extra functionality discussed above. It should be appreciated that in some embodiments, the order of steps 1204 and 1206 may be not critical, and so for example, a player can select the wager they wish to place, and then select the number of paylines they want it applied to, and that these embodiments are expressly contemplated as being within the scope of the present disclosure.

Continuing to step 1208, the gaming system pulls random numbers from a random number generator (“RNG”). In one embodiment, the system pulls one random number for each reel. In another embodiment, the system pulls one random number which may be utilized to determine the stop positions for each reel. In another embodiment, the random numbers determined by the RNG may be based on the time that the numbers may be pulled. In another embodiment, the random numbers determined by the RNG may be based on the prior numbers pulled.

At steps 1210 and 1212, the gaming system utilizes the random numbers pulled at step 1208 to determine the primary game symbols to display in the play of the primary game, which in turn both determines the presentation of the game to the player and evaluates the game outcome. In one embodiment, the random numbers pulled determine the stopping positions for the reels, which may be then caused to stop at those associated positions, and then the gaming system evaluates the displayed primary game symbols to determine the game outcome. In another embodiment, the gaming system determines the game outcome based on the pulled random numbers, and then causes the game to present an associated outcome to the player.

At step 1214, the win or loss outcome may be identified for the player. In one embodiment, this step can include additional messaging, which provides information related to the win or loss, such as why the player won or lost. In another embodiment, this step can include identification of the amount of any award earned by the player.

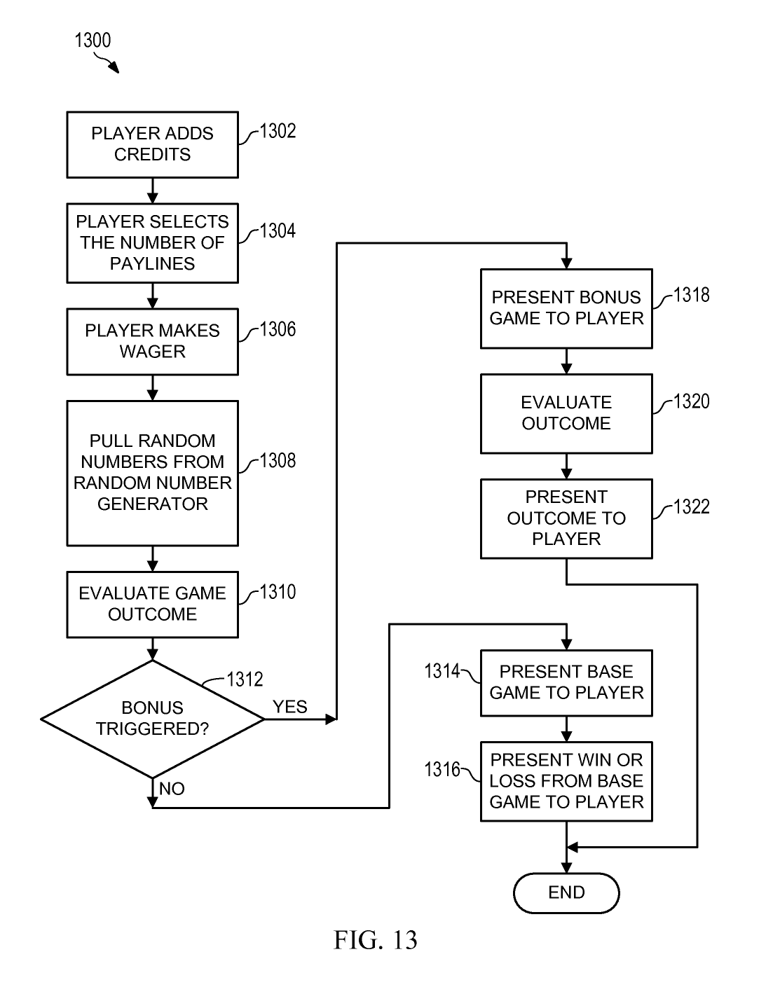

FIG. 13 is a process flowchart of one example of a combined primary and secondary game play 1300 on an electronic gaming system, according to one embodiment. The method may include the step of a player adding credit to the electronic gaming system (step 1302). It is contemplated that a player can do this by inserting cash, coins, a ticket representative of a cash value, a credit card, a player card, requesting an electronic funds transfer (“EFT”), otherwise requesting access to an account having monetary funds, and/or any combination thereof.

At step 1304, the player selects the number of paylines to play. In one embodiment, the player can select from a plurality of different paylines to play. In a further embodiment, the player can only play a predetermined number of paylines. An example of this embodiment may be the instance where the gaming system only allows a player to play forty paylines, and cannot select to play more or less paylines. In another embodiment, the gaming system does not offer paylines, but rather offers a different way to evaluate the game play. One example of a different way may be sometime referred to as a 243-ways evaluation, where symbols may be evaluated based on the existence of like-symbol clusters on adjacent reels, starting with the left-most reel and continuing right, instead of how many paylines run through the like-symbol clusters.

At step 1306, the player makes a wager on the game. In one embodiment, the wager may be a multiple of the number of paylines selected at step 1304. In another embodiment, the wager may not be a multiple of the number of paylines selected at step 1304. In a further embodiment, the wager may include a side-wager, which may, in one example of such an embodiment, be used to make the player eligible to be awarded the extra functionality discussed above. It should be appreciated that in some embodiments, the order of steps 1304 and 1306 may be not critical, and so for example, a player can select the wager they wish to place, and then select the number of paylines they want it applied to, and that these embodiments may be expressly contemplated as being within the scope of the present disclosure.

Continuing to step 1308, the gaming system pulls random numbers from a random number generator “RNG”. In one embodiment, the system pulls one random number for each reel. In another embodiment, the system pulls one random number which may be utilized to determine the stop positions for each reel. In another embodiment, the random numbers determined by the RNG may be based on the time that the numbers may be pulled. In another embodiment, the random numbers determined by the RNG may be based on the prior numbers pulled.

At step 1310, the gaming system utilizes the random numbers pulled at step 1308 to evaluate the game outcome. In one embodiment, the random numbers pulled determine the stopping positions for the reels, which may be then caused to stop at those associated positions, and then the gaming system evaluates the displayed primary game symbols to determine the game outcome. In another embodiment, the gaming system determines the game outcome based on the pulled random numbers, and then causes the game to present an associated outcome to the player.

At step 1312, the gaming system determines if a secondary or bonus game may be triggered. In one embodiment, the bonus game is triggered by the display of a plurality of matching symbols at a plurality of predetermined symbol positions within a play of the primary game. In one example, the bonus game may be triggered if a plurality of matching symbols is displayed on the 2^{nd}, 3^{rd} and 4^{th} reel. In another example, the bonus game may be triggered if matching symbols are displayed on the 1^{st}, 2^{nd} and 3^{rd} reels. In a further example, the bonus game may be triggered if matching symbols occur at predetermined symbol positions that include consecutive and non-consecutive reels. In another example, a bonus game (e.g., secondary game) may be triggered in any way (e.g., one special symbols in any locations, one special symbol in one or more predetermined locations, two special symbols in any locations, two special symbols in one or more predetermined locations, three special symbols in any locations, three special symbols in one or more predetermined locations, etc.).

If it is determined that a bonus or secondary game was not triggered, the process continues to step 1314, where the base game may be fully presented to the player. As discussed above, the orders of step 1310, 1312, and 1614 can be changed without affecting the novel concepts disclosed herein.

At step 1316, the win or loss outcome of the primary game may be identified for the player. In one embodiment, this step can include additional messaging, which provides information related to the win or loss, such as why the player won or lost. In another embodiment, this step can include identification of the amount of any award earned by the player

If it is determined at step 1312 that a bonus or secondary game was triggered, then process 1300 continues to step 1318, where the secondary game may be presented to the player. As discussed above, there are numerous ways to present the secondary or bonus game to the player.

At steps 1320 and 1322, the outcome of the secondary game may be evaluated and presented to the player. In one embodiment, the outcome of the bonus game will always be a winning outcome. In another embodiment, the outcome of the secondary game will cause a significant award to be provided to the player. In one example of such an embodiment, the award may not be provided by the gaming system, as a casino operator may need to verify tax information before allowing such an award to be provided to the player. In one embodiment, instead of the process 1300 ending after step 1322, the process continues to step 1314 so as to finalize the primary game outcome presentation to the player.

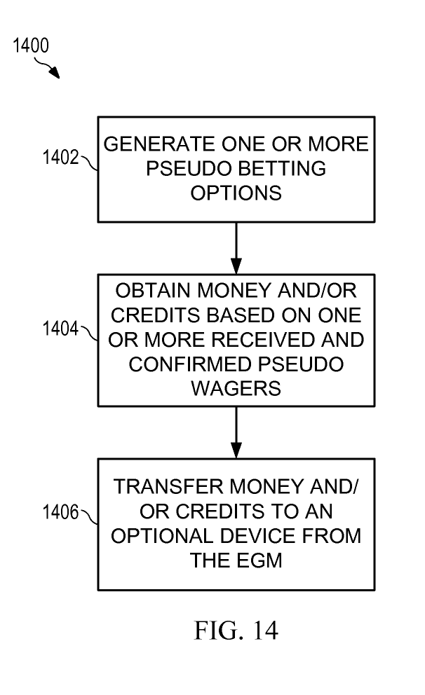

In FIG. 14, a flow diagram for game play 1400 is shown, according to one embodiment. The method may include generating one or more pseudo betting options (step 1402). The method may include obtaining money and/or credits based on one or more received and/or confirmed pseudo wagers (step 1404). The method may include transferring money and/or credits to an optional device from the EGM (step 1406).

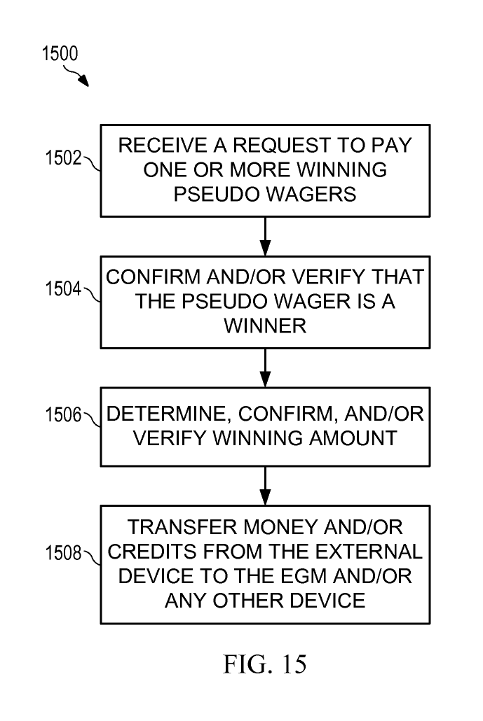

In FIG. 15, a flow diagram for game play 1500 is shown, according to one embodiment. The method may include receiving a request to pay one or more winning pseudo wagers (step 1502). The method may include confirming and/or verifying that the pseudo wager is a winner (step 1504). The method may include determining, confirming, and/or verifying winning amounts (step 1506). The method may include transferring money and/or credits from the external device to the EGM and/or any other device (step 1508).

In another example, a player outside (or inside) of the casino and/or online gaming environment may utilize a mobile device and/or any other device (e.g., computer, etc.) to log into an account on the system and/or a social media interaction system, and/or any other interconnecting system to place a wager, a side bet, and/or a pseudo bet on the game another individual is playing online, at a casino (e.g., Wynn in Vegas, etc.), and/or at any other gaming entity.

One or more sensors may obtain and/or transmit one or more data points (e.g., positional data, temperature data, etc.) relating to one or more audio devices, one or more display devices, audio interface area, audio support area, audio locking device, one or more electrical attachment devices, one or more attachment areas, electronic gaming device 100, electronic gaming system 200, first audio device, wall of the audio installation area, back of the audio installation area, one or more audio interfaces, one or more electrical attachment points, an input area, one or more input devices, second audio device, front-mounted audio device, audio interface locked area, one or more electrical interconnection points, one or more electrical wires, one or more springs, one or more motors, one or more adjustable devices, and/or one or more sensors to one or more processors.

One or more sensors may obtain and/or transmit one or more data points (e.g., positional data, temperature data, etc.) relating to one or more audio devices, one or more display devices, one or more electrical wires, one or more springs, one or more motors, one or more adjustable devices, and/or one or more sensors to one or more processors.

In one embodiment, the electronic gaming device may include a plurality of reels. The one or more paylines may be formed on at least a portion of the plurality of reels. The electronic gaming device may include a memory.

In one embodiment, the electronic gaming device may include a plurality of reels. The plurality of reels may include one or more areas. The electronic gaming device may include a processor and a memory. The memory may include one or more pseudo feature structures. The processor may generate one or more symbols to be located in the one or more areas. In another example, the processor may initiate a base game, a bonus game, and a pseudo game.

In one embodiment, the electronic gaming device may include a plurality of reels where the plurality of reels includes one or more areas. The electronic gaming device includes a memory and a processor. The memory may include one or more pseudo feature structures. The may generate one or more symbols to be located in the one or more areas. The processor may generate one or more pseudo wagering options and the processor may accept one or more pseudo wagers relating to the one or more pseudo wagering options.

In another example, the one or more pseudo wagering options may be based on one or more derivate events relating to the one or more electronic gaming devices. In another example, at least one of the one or more pseudo wagering options may relate to at least one of a winning outcome and a losing outcome. In another example, at least one of the one or more pseudo wagering options may relate to at least one symbol location. In another example, at least one of the one or more pseudo wagering options may relate to at least one symbol characteristic. In another example, at least one of the one or more pseudo wagering options may relate a first symbol comparison to a second symbol. In another example, the one or more pseudo wagering options may be based on non-electronic gaming events. In another example, the non-electronic gaming events may relate to at least one of a sporting event, a tournament, and a horse race. In another example, the one or more pseudo wagering options may be further based on one or more derivate events relating to the one or more electronic gaming devices. Further, at least one of the one or more pseudo wagering options may relate to at least one of a winning outcome and a losing outcome. In one example, at least one of the one or more pseudo wagering options may relate to at least one symbol location. Further, at least one of the one or more pseudo wagering options may relate to at least one symbol characteristic.

In another embodiment, the method of providing game play via an electronic gaming device may include: initiating via one or more processors a base game; initiating via the one or more processors a pseudo game; and/or determining one or more outcomes associated with the base game and the pseudo game.

Further, the method may include that the pseudo game is based on one or more derivate events relating to the one or more electronic gaming devices. Further, the pseudo game is further based on non-electronic gaming events. In addition, the pseudo game relates to at least one of a winning outcome and a losing outcome.

In another embodiment, an electronic gaming system may include a server which includes a server processor and a server memory. Further, a display device including a plurality of reels where the plurality of reels include one or more areas. The server memory may include one or more pseudo feature structures. The server processor may generate one or more pseudo wagering options and/or the server processor may accept one or more pseudo wagers relating to the one or more pseudo wagering options.

In another example, the one or more pseudo wagering options are based on one or more derivate events relating to the one or more electronic gaming devices. Further, at least one of the one or more pseudo wagering options relates to at least one of a winning outcome and a losing outcome. In another example, the one or more pseudo wagering options are based on non-electronic gaming events.

Gaming system may be a “state-based” system. A state-based system stores and maintains the system's current state in a non-volatile memory. Therefore, if a power failure or other malfunction occurs, the gaming system will return to the gaming system's state before the power failure or other malfunction occurred when the gaming system is powered up.

State-based gaming systems may have various functions (e.g., wagering, payline selections, reel selections, game play, bonus game play, evaluation of game play, game play result, steps of graphical representations, etc.) of the game. Each function may define a state. Further, the gaming system may store game histories, which may be utilized to reconstruct previous game plays.

A state-based system is different than a Personal Computer (“PC”) because a PC is not a state-based machine. A state-based system has different software and hardware design requirements as compared to a PC system.

The gaming system may include random number generators, authentication procedures, authentication keys, and operating system kernels. These devices, modules, software, and/or procedures may allow a gaming authority to track, verify, supervise, and manage the gaming system's codes and data.

A gaming system may include state-based software architecture, state-based supporting hardware, watchdog timers, voltage monitoring systems, trust memory, gaming system designed communication interfaces, and security monitoring.

For regulatory purposes, the gaming system may be designed to prevent the gaming system's owner from misusing (e.g., cheating) via the gaming system. The gaming system may be designed to be static and monolithic.

In one example, the instructions coded in the gaming system are non-changeable (e.g., static) and are approved by a gaming authority and installation of the codes are supervised by the gaming authority. Any change in the system may require approval from the gaming authority. Further, a gaming system may have a procedure/device to validate the code and prevent the code from being utilized if the code is invalid. The hardware and software configurations are designed to comply with the gaming authorities' requirements.

As used herein, the term “mobile device” refers to a device that may from time to time have a position that changes. Such changes in position may comprise of changes to direction, distance, and/or orientation. In particular examples, a mobile device may comprise of a cellular telephone, wireless communication device, user equipment, laptop computer, other personal communication system (“PCS”) device, personal digital assistant (“PDA”), personal audio device (“PAD”), portable navigational device, or other portable communication device. A mobile device may also comprise of a processor or computing platform adapted to perform functions controlled by machine-readable instructions.

The methods and/or methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or a special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the arts to convey the substance of their work to others skilled in the art. An algorithm is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference throughout this specification to “one example,” “an example,” “embodiment,” and/or “another example” should be considered to mean that the particular features, structures, or characteristics may be combined in one or more examples.

While there has been illustrated and described what are presently considered to be example features, it will be understood by those skilled in the art that various other modifications may be made, and equivalents may be substituted, without departing from the disclosed subject matter. Additionally, many modifications may be made to adapt a particular situation to the teachings of the disclosed subject matter without departing from the central concept described herein. Therefore, it is intended that the disclosed subject matter not be limited to the particular examples disclosed. Further, one or more gaming options may be Internet based gaming options. Therefore, all of the examples and/or embodiments may be utilized via an Internet based gaming system.

1. An electronic gaming device comprising:
a plurality of reels, the plurality of reels including one or more areas;
a memory, the memory including one or more pseudo feature structures;
a processor configured to generate one or more symbols to be located in the one or more areas, the processor configured to generate one or more pseudo wagering options and the processor configured to accept one or more pseudo wagers relating to the one or more pseudo wagering options.

2. The electronic gaming device of claim 1, wherein the one or more pseudo wagering options are based on one or more derivate events relating to the one or more electronic gaming devices.

3. The electronic gaming device of claim 2, wherein at least one of the one or more pseudo wagering options relates to at least one of a winning outcome and a losing outcome.

4. The electronic gaming device of claim 2, wherein at least one of the one or more pseudo wagering options relates to at least one symbol location.

5. The electronic gaming device of claim 2, at least one of the one or more pseudo wagering options relates to at least one symbol characteristic.

6. The electronic gaming device of claim 2, at least one of the one or more pseudo wagering options relates a first symbol comparison to a second symbol.

7. The electronic gaming device of claim 1, wherein the one or more pseudo wagering options are based on non-electronic gaming events.

8. The electronic gaming device of claim 7, wherein the non-electronic gaming events relate to at least one of a sporting event, a tournament, and a horse race.

9. The electronic gaming device of claim 7, wherein the one or more pseudo wagering options are further based on one or more derivate events relating to the one or more electronic gaming devices.

10. The electronic gaming device of claim 9, wherein at least one of the one or more pseudo wagering options relates to at least one of a winning outcome and a losing outcome.

11. The electronic gaming device of claim 9, wherein at least one of the one or more pseudo wagering options relates to at least one symbol location.

12. The electronic gaming device of claim 9, at least one of the one or more pseudo wagering options relates to at least one symbol characteristic.

13. A method of providing game play via an electronic mobile device comprising:
initiating via the one or more processors a pseudo game; and
determining one or more outcomes associated with the pseudo game.

14. The method of claim 13, wherein the pseudo game is based on one or more derivate events relating to the one or more electronic gaming devices.

15. The method of claim 14, wherein the pseudo game is further based on non-electronic gaming events.

16. The method of claim 14, wherein the pseudo game relates to at least one of a winning outcome and a losing outcome.

17. An electronic gaming system comprising:
a server including a server processor and a server memory;
a display device including a plurality of reels, the plurality of reels including one or more areas;
the server memory including one or more pseudo feature structures; and
the server processor is configured to generate one or more pseudo wagering options and the server processor configured to accept one or more pseudo wagers relating to the one or more pseudo wagering options.

18. The electronic gaming system of claim 17, wherein the one or more pseudo wagering options are based on one or more derivate events relating to the one or more electronic gaming devices.

19. The electronic gaming system of claim 17, wherein at least one of the one or more pseudo wagering options relates to at least one of a winning outcome and a losing outcome.

20. The electronic gaming system of claim 17, wherein the one or more pseudo wagering options are based on non-electronic gaming events.
